(19) United States
(12) Patent Application Publication
(10) Pub. No.: US 2024/0275549 A1
(43) Pub. Date: Aug. 15, 2024

(54) METHOD AND APPARATUS FOR POSITIONING IN A WIRELESS COMMUNICATION SYSTEM

(71) Applicant: SAMSUNG ELECTRONICS CO., LTD., Suwon-si (KR)

(72) Inventors: Cheolkyu SHIN, Suwon-si (KR); Kyoungmin PARK, Suwon-si (KR); Hyunseok RYU, Suwon-si (KR); Junyung YI, Suwon-si (KR)

(21) Appl. No.: 18/440,580

(22) Filed: Feb. 13, 2024

(30) Foreign Application Priority Data
Feb. 15, 2023 (KR) 10-2023-0020341
Apr. 21, 2023 (KR) 10-2023-0052857

(51) Int. Cl. H04L 5/00; H04W 64/00

(52) U.S. Cl. CPC H04L 5/0051; H04W 64/00

(57) ABSTRACT

The disclosure relates to a 5G or 6G communication system for supporting a higher data transmission rate. More particularly, disclosed is a method and apparatus for performing resource selection and signal transmission or reception for positioning between UEs. According to various embodiments, a method performed by a first user equipment (UE) in a wireless communication system, the method comprising: transmitting, to a second UE, a first sidelink positioning reference signal (SL PRS); receiving, from the second UE, a second SL PRS; and identifying a SL PRS time difference based on the first SL PRS and the second SL PRS, wherein the SL PRS time difference is a difference between a received timing of a sidelink subframe #i associated with the first SL PRS and a transmit timing of a sidelink subframe #j associated with the second SL PRS, according to an indication via a higher layer signaling.

### CROSS-REFERENCE TO RELATED APPLICATIONS

This application is based on and claims priority under 35 U.S.C. § 119 to Korean Patent Application No. 10-2023-0020341 filed on Feb. 15, 2023, and Korean Patent Application No. 10-2023-0052857 filed on Apr. 21, 2023, in the Korean Intellectual Property Office, the disclosures of which are herein incorporated by reference in their entirety.

### BACKGROUND

### 1. Field

The disclosure relates to a wireless communication system (or a mobile communication system) and, more particularly, to a method and apparatus for performing positioning (e.g., location measurement) in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

As communication systems have developed, a desire for increasing efficiency of measuring a location of a user equipment (UE) has been gradually increased.

The above information is presented as background information only to assist with an understanding of the disclosure. No determination has been made, and no assertion is made, as to whether any of the above might be applicable as prior art with regard to the disclosure.

### SUMMARY

The disclosure relates to a wireless communication system and, more particularly, to a method and apparatus for performing positioning (e.g., location measurement) in a wireless communication system.

Particularly, the disclosure proposes methods that use a round trip time (RTT) when performing positioning via a sidelink. However, according to various embodiments of the disclosure, the content proposed in the disclosure, of course, is not limitedly applied to a sidelink.

A control signal processing method of a user equipment (UE) according to an embodiment proposed in the disclosure may include an operation of receiving a first control signal transmitted from a base station, an operation of processing the received first control signal, and an operation of transmitting, to the base station, a second control signal produced based on the processing.

According to various embodiments proposed in the disclosure, a UE may effectively perform positioning (e.g., location measurement).

Advantageous effects obtainable from the disclosure may not be limited to the above-mentioned effects, and other effects which are not mentioned may be clearly understood, through the following descriptions, by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a diagram of examples of the environment of a wireless communication system according to various embodiments of the disclosure;

FIG. 2 illustrates a diagram of a communication method performed via a sidelink according to various embodiments of the disclosure;

FIG. 3 illustrates a diagram of an example of a resource pool used for transmission and reception in a sidelink according to various embodiments of the disclosure;

FIGS. 4 to 6 illustrates diagrams of various examples of measuring a location of a user equipment (UE) via a sidelink according to various embodiments of the disclosure;

FIG. 7 illustrates a diagram of an example of performing positioning by using a round trip time (RTT) scheme according to various embodiments of the disclosure;

FIGS. 8 and 9 illustrate diagrams of examples of performing positioning using a new RTT scheme according to various embodiments of the disclosure;

FIG. 10 illustrates a flowchart of operations for performing positioning using an RTT scheme according to various embodiments of the disclosure;

FIG. 11 illustrates a flowchart of operations for performing positioning using another RTT scheme according to various embodiments of the disclosure;

FIG. 12 illustrates a diagram of an example of a difference in time between a received S-PRS signal and a transmitted S-PRS signal according to various embodiments of the disclosure;

FIG. 13 illustrates a diagram of another example of a difference in time between a received S-PRS signal and a transmitted S-PRS signal according to various embodiments of the disclosure;

FIG. 14 illustrates a diagram of an example of a sensing window and a resource selection window according to various embodiments of the disclosure;

FIG. 15 illustrates a diagram of an example of a physical channel structure in which an S-PRS is transmitted according to various embodiments of the disclosure;

FIG. 16 illustrates a diagram of a functional configuration of a UE according to various embodiments of the disclosure; and

FIG. 17 illustrates a diagram of a functional configuration of a base station according to various embodiments of the disclosure.

### DETAILED DESCRIPTION

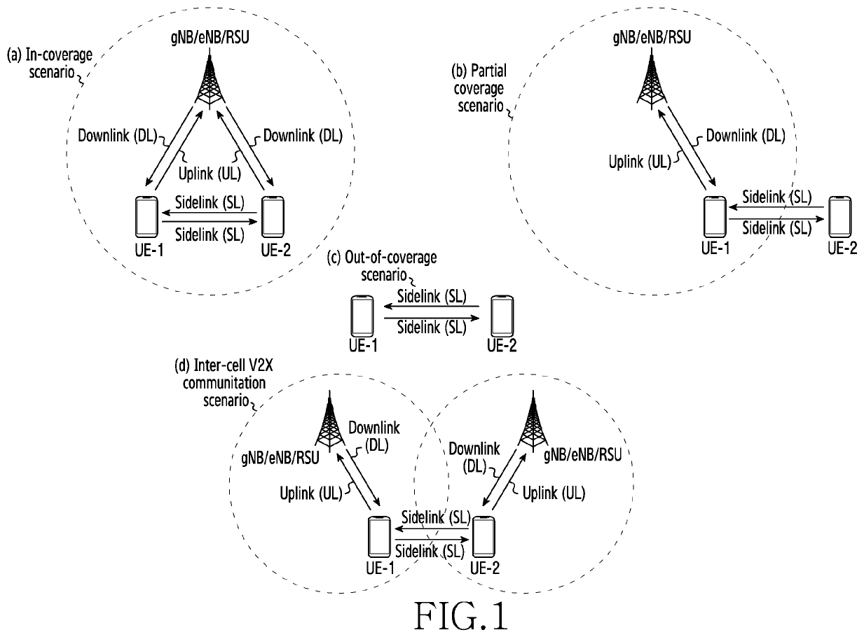

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings. In describing the embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea. For the same reason, in the accompanying drawings, some elements may be exaggerated, omitted, or schematically illustrated. Further, the size of each element does not completely reflect the actual size. In the drawings, identical or corresponding elements are provided with identical reference numerals. The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

According to various embodiments, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in the embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Furthermore, the “unit” in the embodiments may include one or more processors.

The following detailed description of embodiments of the disclosure is directed to New RAN (or new radio (NR)) as a radio access network and Packet Core (5G system (5GS), 5G Core Network, or next generation core (NG Core)) as a core network, which are specified in the 5G mobile communication standards defined by the 3rd generation partnership project long term evolution (3GPP LTE) that is a mobile communication standardization group, but based on determinations by those skilled in the art, the main idea of the disclosure may be applied to other communication systems having similar backgrounds or channel types through some modifications without significantly departing from the scope of the disclosure.

In the 5G system, a network data collection and analysis function (NWDAF), which is a network function of collecting, analyzing, and providing data in the 5G network, may be defined to support network automation. The NWDAF may collect/store/analyze information from a 5G network and provide the analysis result to an unspecified network function (NF), and the analysis result may be used independently at each NF.

In the following description, some of terms and names defined in the 3GPP standards may be used for the sake of descriptive convenience. However, the disclosure is not limited by these terms and names, and may be applied in the same way to systems that conform other standards.

Furthermore, in the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

To meet the demand for wireless data traffic having increased since deployment of 4G communication systems, efforts have been made to develop an improved 5G communication system (NR, new radio). To accomplish higher data rates, the 5G communication system is designed to enable resources in ultrahigh frequency (mmWave) bands (e.g., 28 GHz frequency band). To decrease propagation loss of the radio waves and increase the transmission distance, the beamforming, massive multiple-input multiple-output (massive MIMO), full dimensional MIMO (FD-MIMO), array antenna, analog beamforming, and large scale antenna techniques have been discussed in the 5G communication system. Unlike the LTE, the 5G communication system supports various subcarrier spacings, such as 15 kHz, 30 kHz, 60 kHz, and 120 kHz, uses a polar coding for a physical control channel, and uses a low density parity check (LDPC) for a physical data channel. In addition, CP-OFDM as well as DFT-S-OFDM are used as a waveform for uplink transmission. The LTE supports hybrid ARQ (HARQ) retransmission in units of transport blocks (TBs) whereas the 5G can additionally support HARQ retransmission based on a code block group (CBG) in which a plurality of code blocks (CBs) is bundled.

Furthermore, in the 5G communication system, development for system network improvement is under way based on an advanced small cell, a cloud radio access network (cloud RAN), an ultra-dense network, device-to-device (D2D) communication, wireless backhaul, a vehicle-to-everything (V2X) network, cooperative communication, coordinated multi-points (CoMP), reception-end interference cancellation, and the like.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, machine type communication (MTC), and machine-to-machine (M2M) communication may be implemented by beamforming, MIMO, and array antennas. Application of a cloud radio access network (cloud RAN) as the above-described big data processing technology may also be considered an example of convergence of the 5G technology with the IoT technology. As such, a plurality of services may be provided to users in a communication system. In order to provide such a plurality of services to users, there is a need for a method and apparatus which can provide the respective services within the same time interval according to their characteristics.

Research on various services provided in the 5G communication system are being conducted, and one of them is a service that satisfies requirements of low latency and high reliability. In addition, the demand for mobile services is explosively increasing and a location based service (LBS) led by two requirements, that is, an emergency service and a commercial application are growing rapidly. In the case of communication via a sidelink, unicast communication, groupcast (or multicast) communication, and broadcast communication between UEs may be supported in an NR sidelink system. Unlike LTE sidelink for transmission or reception of basic safety information, which is needed when a vehicle drives on a road, an NR sidelink is to provide an advanced service such as platooning, advanced driving, an extended sensor, or remote driving.

Particularly, in an NR sidelink, positioning (e.g., location measurement) may be performed via sidelink between UEs. According to an embodiment, a method of measuring the location of a UE by using a positioning signal transmitted via a sidelink may be considered. An existing method of measuring the location of a UE via a positioning signal transmitted via a downlink and an uplink of the UE and a base station may be available only when the UE is in base station coverage. However, in the case in which sidelink positioning is employed, the location of a UE is measurable even when the UE is outside the base station coverage. In the disclosure, there is provided a positioning method using a round trip time (RTT) in a sidelink.

A positioning signal in a sidelink may be referred to as a sidelink-positioning reference signal (S-PRS). However, this may be surely replaced with another term. First, a procedure for performing RTT in a sidelink needs to be defined. In addition, to secure accuracy of sidelink positioning, a method of transmitting an S-PRS needs to be designed newly. Specifically, a resource allocation method for S-PRS transmission may be performed in a manner different from an existing resource allocation method for data transmission. In addition, a physical layer structure used when an S-PRS is transmitted may be different from an existing physical layer structure. Information needed for performing RTT may need to be exchanged between sidelink UEs.

The disclosure proposes the above-described methods so as to provide various embodiments that perform positioning in a sidelink. However, technology proposed in the disclosure, of course, is not limitedly applied to a sidelink. Specifically, RTT methods described below may also be applied to normal device-to-device (D2D) positioning or Uu positioning.

Various embodiments of the disclosure support the above-described scenario, and provides a method and apparatus for measuring the location of a UE (hereinafter, positioning).

FIG. 1 illustrates a diagram of examples of the environment of a wireless communication system according to various embodiments of the disclosure.

Part (a) of FIG. 1 illustrates the case in which all UEs (UE-1 and UE-2) that perform communication via a sidelink are located in the coverage of a base station (e.g., In-Coverage (IC)). All the UEs may receive data and control information from the base station in a downlink (DL), or may transmit data and control information to the base station in an uplink (UL). In this instance, the data and control information may include data and control information for sidelink communication. The data and control information may include data and control information for general cellular communication. In addition, the UEs may transmit or receive data and control information for the corresponding communication via a sidelink (SL).

Part (b) of FIG. 1 illustrates the case in which UE-1 among the UEs is located in the coverage of a base station, and UE-2 is located outside the coverage of the base station. That is, part (b) of FIG. 1 illustrates an example of a partial coverage (PC) when a UE (UE-2) is located outside the coverage of the base station. UE-1 located in the coverage of the base station may receive data and control information from a base station in a downlink or may transmit data and control information to the base station in an uplink. UE-2 located outside the coverage of the base station may be incapable of receiving data and control information from the base station in a downlink or may be incapable of transmitting data and control information to the base station in an uplink. In this instance, the UE (UE-2) may perform transmission or reception of data and control information with the UE (UE-1) for the corresponding communication via a sidelink.

Part (c) of FIG. 1 illustrates the case in which all UEs are located outside the coverage of a base station (out-of-coverage (OOC)). Therefore, the UEs (UE-1 and UE-2) may be incapable of receiving data and control information from the base station in a downlink or may be incapable of transmitting data and control information to the base station in an uplink. The UEs (UE-1 and UE-2) may perform transmission/reception of data and control information via a sidelink.

Part (d) of FIG. 1 illustrates an example of a scenario in which sidelink communication is performed between the UEs (UE-1 and UE-2) located in different cells. Specifically, part (d) of FIG. 1 illustrates the case in which the UEs (UE-1 and UE-2) are connected to different base stations (e.g., radio resource control (RRC) connected state) or camped on different base stations (e.g., RRC disconnected state or RRC idle state). In this instance, the UE (UE-1) may be a transmission UE and the UE (UE-2) may be a reception UE in a sidelink. Conversely, the UE (UE-1) may be a reception UE and the UE (UE-2) may be a transmission UE in a sidelink. The UE (UE-1) may be capable of receiving a system information block (SIB) from a base station that the UE (UE-1) accesses (or camps on), and the UE (UE-2) may be capable of receiving an SIB from another base station that the UE (UE-2) accesses (or camps on). In this instance, as an SIB that the base station transmits, an existing normal SIB may be used, or an SIB defined separately for sidelink communication may be used. In addition, information associated with an SIB that the UE (UE-1) receives, and information associated with an SIB that the UE (UE-2) receives, may be different from each other. Therefore, in order to perform sidelink communication between UEs (UE-1 and UE-2) located in different cells, information may need to be identical or information associated therewith may need to be signaled, so that identifying and interpreting SIB information transmitted respectively from different cells may be additionally needed.

Although FIG. 1 illustrates a sidelink system including two UEs (UE-1 and UE-2) for ease of description, the disclosure is not limited thereto but communication between a large number of UEs in a wireless communication system may be performed. In addition, an interface (uplink and downlink) between a base station and each UE may be referred to as a Uu interface, and sidelink communication between UEs may be referred to as a PC5 interface. Therefore, in the disclosure, the terms may be interchangeably used. In the disclosure, a UE may include a general UE or a UE that supports vehicle-to-everything (V2X). Specifically, the UE in the disclosure may be a handset (e.g., a smartphone) of a pedestrian. Alternatively, a UE may include at least one among a vehicle that supports vehicle-to-vehicle (V2V) communication, a vehicle that supports vehicle-to-pedestrian (V2P) communication, a vehicle that supports vehicle-to-network (V2N) communication, or a vehicle that supports vehicle-to-infrastructure (V2I) communication. In addition, a UE in the disclosure may include at least one among a road side unit (RSU) equipped with a UE function, an RSU equipped with a base station function, or an RSU equipped with part of a base station function and part of a UE function. In addition, according to an embodiment of the disclosure, a base station may be a base station that supports both V2X communication and general cellular communication, or may be a base station that supports only V2X communication. In this instance, the base station may include at least one of a 5G base station (gNB), a 4G base station (eNB), or an RSU. Hereinafter, for ease of description, a base station in the disclosure may be referred to as an RSU.

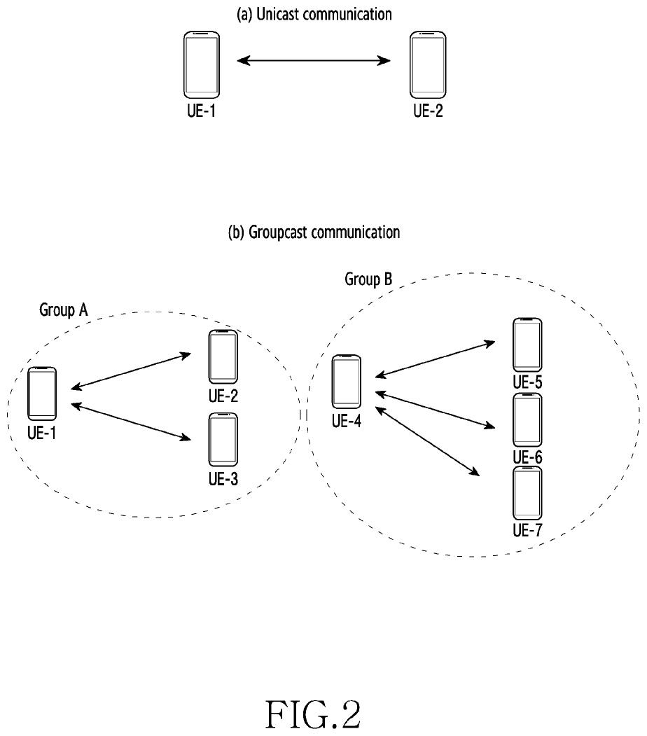

FIG. 2 illustrates a diagram of a communication method performed via a sidelink according to various embodiments of the disclosure.

Referring to part (a) of FIG. 2, UE-1 (e.g., a TX UE) and UE-2 (e.g., an RX UE) may perform one-to-one communication, and this is referred to as unicast communication. In a sidelink, capability information or configuration information may be exchanged between UEs via PC5-RRC defined in unicast link between the UEs. In addition, configuration information may be exchanged via a sidelink medium access control (MAC) control element (CE) defined in a unicast link between the UEs. The configuration information may include at least one piece of information among a destination identifier (ID) or a source ID. In this instance, information exchange method for a unicast is not limited to the above-described PC5-RRC or MAC-CE. The information for unicast may be included in sidelink control information (SCI) (e.g., 1st SCI or 2nd SCI). In addition, part of the information for unicast may be transmitted via SCI, and the remaining part may be included in another channel and transmitted via PC5-RRC or a MAC-CE.

According to part (b) of FIG. 2, a TX UE and an RX UE may perform one-to-multiple communication, which may be referred to as groupcast or multicast. In part (b) of FIG. 2, UE-1, UE-2, and UE-3 may constitute a single group (Group A) and may perform groupcast communication. UE-4, UE-5, UE-6, and UE-7 may constitute another group (Group B) and may perform groupcast communication. Each UE may perform groupcast communication only in a group which the corresponding UE belongs to, and communication between different groups may be performed via unicast, groupcast, or broadcast communication. Although part (b) of FIG. 2 illustrates an example in which two groups (Group A and Group B) are configured, the disclosure is not limited thereto.

Although not illustrated in FIG. 2, UEs may perform broadcast communication in a sidelink. The broadcast communication refers to the case in which all other UEs receive data and control information that a transmission UE or a base station transmits via a sidelink. For example, in the case in which UE-1 is a transmission UE for broadcast in part (b) of FIG. 2, all UEs (UE-2, UE-3, UE-4, UE-5, UE-6, and UE-7) may receive data and control information that UE-1 transmits.

Supporting a process in which a vehicle UE transmits data to only a single predetermined node via a unicast, and a process in which a vehicle UE transmits data to multiple predetermined nodes via a groupcast may be considered in NR V2X, unlike LTE V2X. For example, unicast and groupcast technologies may be effectively used when a service scenario, such as group driving (e.g., platooning), is considered, which is technology in which two or more vehicles are connected over a single network, and move in a manner of being bounded as a group. Specifically, unicast communication may be needed when a leader node in a group connected for group driving desires to control a single predetermined node, and group cast communication may be needed when a leader node desires to simultaneously control a group including multiple predetermined nodes.

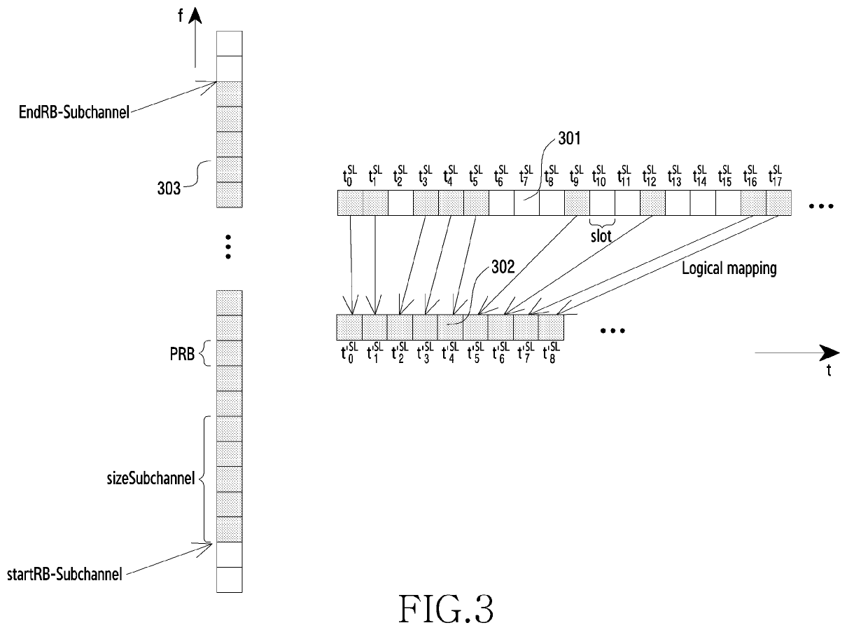

FIG. 3 illustrates a diagram of an example of a resource pool used for transmission and reception in a sidelink according to various embodiments of the disclosure. Specifically, FIG. 3 illustrates a diagram of a resource pool defined as a set of resources in time and frequency used for transmission and reception in a sidelink.

According to an embodiment, in a resource pool, a resource allocation unit (resource granularity) in the time axis may be a slot. In addition, a resource allocation unit in the frequency axis may be a sub-channel including one or more physical resource blocks (PRBs). According to various embodiments of the disclosure, although there is described the case in which a resource pool is allocated discontiguously in the time domain, a resource pool may be allocated contiguously in the time domain. In addition, although the disclosure provides a description with reference to the case in which a resource pool is contiguously allocated in the frequency domain, a method of discontiguously allocating a resource pool in the frequency domain is not excluded.

Referring to FIG. 3, a case in which a resource pool is discontiguously allocated in the time domain is illustrated. Referring to FIG. 3, the case in which a resource allocation unit (granularity) in the time domain is a slot is illustrated. A sidelink slot may be defined in a slot used for an uplink. Specifically, the length of a symbol used for a sidelink in a single slot may be configured as sidelink bandwidth part (BWP) information. Therefore, slots of which the length of a symbol configured for a sidelink is not secured among slots used for an uplink may not be used as a sidelink slot. In addition, a slot in which a sidelink SSB (S-SSB) is transmitted may be excluded from slots that belong to a resource pool.

Referring to a first resource grid 301, a set of slots capable of being used for a sidelink in the time domain, excluding the above-described slots, is illustrated as (t₀^{SL}, t₁^{SL}, t₂^{SL}, . . . ). A part colored in the first resource grid 301 may be sidelink slots that belong to a resource pool. The sidelink slots that belong to the resource pool may be configured (or previously configured) (hereinafter, (pre-)configuration) based on resource pool information via a bitmap.

Referring to a second resource grid 302, a set of sidelink slots that belong to a resource pool in the time domain is illustrated as (t′₀^{SL}, t′₁^{SL}, t′₂^{SL}, . . . ). In the disclosure, (pre-)configuration information may include configuration information that is pre-configured in a UE and stored in advance, or may include information configured for a UE by a base station via a cell-common method. Here, the cell-common method refers to a method in which UEs in a cell receive identical configuration information from a base station. In this instance, a method in which a UE receives a sidelink-system information block (SL-SIB) from a base station, and obtains cell-common information, may be considered. In addition, (pre-)configuration also refers to the case in which a UE establishes an RRC connection with a base station, and configuration is performed in a UE-specific manner. Here, the term ‘UE-specific’ may be replaced with the term ‘UE-dedicated’ and may refer to a scheme in which a UE receives a value specific for each UE as configuration information. In this instance, a UE may receive UE-specific information by receiving an RRC message from a base station.

According to an embodiment, there may be a method in which (pre-) configuration is configured as resource pool information or a method in which (pre-) configuration is not configured in resource pool information. In the case in which (pre-)configuration is performed based on resource pool information, UEs that operate in the corresponding resource pool may operate based on common configuration information, excluding the case in which a UE establishes an RRC connection with a base station and configuration is performed in a UE-specific manner. The method in which (pre-)configuration is not configured in the resource pool information may basically refer to a method in which (pre-)configuration is configured independently from resource pool configuration information. For example, one or more modes (e.g., modes A, B, and C) are (pre-)configured in a resource pool, and which (e.g., mode A, or B, or C) of the modes (pre-)configured in the resource pool is to be used may be indicated based on information (pre-)configured independently from the resource pool configuration information. In addition, (pre-)configuration may be performed via PC5-RRC in sidelink unicast transmission. Alternatively, a method in which (pre-)configuration is performed via a MAC-CE may be considered. In the disclosure, in the case in which (pre-)configuration is performed, all the above-described cases may be applied, as a matter of course.

Referring to a third resource grid 303, the case in which a resource pool is contiguously allocated in the frequency domain is illustrated. The resource allocation in the frequency domain may be configured based on sidelink BWP information, and may be performed in units of sub-channels. A sub-channel may be defined as a resource allocation unit, including one or more PRBs, in the frequency domain. That is, a sub-channel may be defined by an integer multiple of an PRB. Referring to the third resource grid 303, a sub-channel may include 5 consecutive PRBs, and a sub-channel size (sizeSubchannel) may be the size of 5 consecutive PRBs. The content illustrated in the drawing is merely an example of the disclosure, and the size of a sub-channel may be configured to be different, or a single sub-channel may be generally configured with consecutive PRBs but a sub-channel may not always need to be configured with consecutive PRBs. A sub-channel may be a basic unit of resource allocation for a physical sidelink shared channel (PSSCH). In the third resource grid 303, startRB-Subchannel denotes the start location of a sub-channel in the frequency domain in a resource pool. In the case in which resource allocation is performed in units of sub-channels in the frequency domain, resources may be allocated in the frequency domain based on configuration information associated with a resource block (RB) index (startRB-Subchannel) indicating the start of a subchannel, information (sizeSubchannel) indicating the number of PRBs is included in a subchannel, the total number (numSubchannel) of subchannels, or the like. In this instance, information associated with startRB-Subchannel, sizeSubchannel, numSubchannel, or the like may be (pre-)configured as frequency-domain resource pool information.

As one of the methods of allocating a transmission resource in a sidelink, there may be a method of allocating a sidelink transmission resource from a base station in the case in which a UE is inside the coverage of a base station. Hereinafter, the method may be referred to as Mode 1. For example, Mode 1 is a scheduling method dedicated to UEs having an RRC connection with a base station and may include a method of allocating resources used for sidelink transmission. According to the method of Mode 1, a base station is capable of managing a sidelink resource, and thus the method of Mode 1 may be effective for interference management and resource pool management.

Unlike the above, among the methods of allocating a transmission resource in a sidelink, there may be a method in which a UE allocates a transmission resource via direct sensing in a sidelink. Hereinafter, the method may be referred to as Mode 2. Mode 2 may also be referred to as UE autonomous resource selection. Unlike Mode 1 in which a base station is directly involved in resource allocation, a transmission UE in Mode 2 may autonomously select a resource via a sensing and resource select procedure defined based on a (pre-)configured resource pool, and may transmit data via the selected resource. After allocating a transmission resource via Model 1 or Model 2, a UE may transmit or receive data and control information via a sidelink. Here, the control information may include SCI format 1-A as 1st stage sidelink control information (SCI) transmitted via a physical sidelink control channel (PSCCH). In addition, the control information may include at least one of SCI format 2-A or SCI format 2-B as 2nd stage SCI transmitted via a physical sidelink shared channel (PSSCH).

Hereinafter, as a positioning method that measures the location of a UE, a method that uses a positioning signal (positioning reference signal (PRS)) transmitted in a downlink and an uplink of a base station and a UE will be described. In the disclosure, the method that uses a positioning signal transmitted in a downlink and an uplink of a base station and a UE may be referred to as radio access technology (RAT) dependent positioning. In addition, positioning methods other than that may be included in RAT-independent positioning.

Specifically, in the case of an LTE system, as an RAT-dependent positioning scheme, methods such as an observed time difference of arrival (OTDOA), an uplink time difference of arrival (UTDOA), and an enhanced cell identification (E-CID) may be used. In the case of an NR system, as an RAT-dependent positioning scheme, methods such as a downlink time difference of arrival (DL-TDOA), a downlink angle-of-departure (DL-AOD), a multi-round trip time (Multi-RTT), NR E-CID, an uplink time difference of arrival (UL-TDOA), and an uplink angle-of-arrival (UL-AOA) may be used. Unlike the above, an RAT-independent positioning scheme may include methods such as an assisted global navigation satellite systems (A-GNSS), a sensor, a wireless local area network (WLAN), and Bluetooth.

In the disclosure, descriptions will be provided mainly based on an RAT-dependent positioning method supported via a sidelink. In the case of an interface (e.g., an uplink and a downlink, hereinafter, a Uu) between a base station and UEs, RAT-dependent positioning may be performed only when a UE is in the coverage of a base station. However, RAT-dependent positioning of a sidelink may not be limited to the case in which a UE is in the coverage of a base station.

In the case of RAT-dependent positioning in a Uu, a positioning protocol such as an LTE positioning protocol (LPP), LTE positioning protocol annex (LPPa), and an NR positioning protocol annex (NRPPa) may be used. The LPP is a positioning protocol defined between a UE and a location server (LS), and the LPPa and NRPPa are protocols defined between a base station and a location server. Here, the location server may be a subject of managing location measurement, and may perform a function of a location management function (LMF). In addition, the location server may be referred to as an LMF or another name. Both the LTE and NR systems may support an LPP, and operations listed below may be performed for positioning via an LPP.
Exchange positioning capability
Transmit assistance data
Transmit location information
Process an error
Abort

According to an embodiment, when a UE and a location server perform the above-described operation via an LPP, a base station may perform management so that the UE and the location server exchange positioning information. In this instance, exchanging of positioning information via an LPP may be performed to be transparent to the base station. This implies that the base station is not involved in exchanging of positioning information performed between the UE and the location server.

According to an embodiment, in the case of positioning capability, a UE may exchange supportable positioning information with a location server. For example, the positioning information supportable by a UE may indicate whether a positioning method supported by the UE is a UE-assisted method or UE-based method, or whether both methods are available. In the case of the UE-assisted method, the UE may not autonomously measure an absolute position, and may transfer, to the location server, a measurement value associated with a positioning scheme based on an applied received positioning signal, so that the location server may calculate the absolute position of the UE. Here, the absolute position may be two-dimensional (x, y) or three-dimensional (x, y, z) coordinate location information of a UE based on longitude and latitude. In the case of the UE-based method, the UE may autonomously measure the absolute position of the UE. To this end, the UE may need to receive a positioning signal, together with location information of a subject that sends the positioning signal. When compared to the LTE system that only supports a UE-assisted method, the NR system supports all positioning methods based on a UE-assisted method or a UE-based method.

According to an embodiment, to measure an accurate location of a UE, assistance data transmission may be a very important operation in positioning. Specifically, based on assistance data transmission, a location server may provide, to a UE, configuration information associated with a positioning signal, information associated with a transmission reception point (TRP) and a candidate cell that is to receive a positioning signal, or the like. Specifically, in the case in which a DL-TDOA is used, the information associated with a TRP and a candidate cell that is to receive a positioning signal may include information associated with a reference cell and a reference TRP, and information associated with a neighbor cell and a neighbor TRP. In addition, together with a plurality of candidates for a neighbor cell and a neighbor TRP, information associated with which cell and TRP may need to be selected for measuring a positioning signal. In order to measure an accurate location, the UE may need to appropriately select a candidate cell and TRP information that is a reference for measuring an accurate location. For example, in the case in which a channel associated with a positioning signal received from the corresponding candidate cell and TRP is a line-of-sight (LOS) channel (e.g., a channel having a low non-LOS (NLOS) channel component), the accuracy of a positioning measurement may be increased. Therefore, when there is provided candidate cell and TRP information that is a reference when a location server collects various types of information and performs positioning, the UE may perform accurate positioning measurement.

According to an embodiment, location information transmission may be performed via an LPP. A location server may request location information from a UE, and the UE may provide measured location information to the location server in response to the corresponding request. In the case of a UE-assisted method, the corresponding location information may be a measurement value associated with a position scheme based on a received positioning signal. In the case of a UE-based method, the corresponding location information may be a two-dimensional (x, y) or three-dimensional coordinate location value of the UE. When the location server requests location information from the UE, the location server may include required accuracy and response time and the like in quality of service (QoS) information. When the corresponding positioning QoS information is requested, the UE may need to provide, to the location server, location information measured to satisfy the corresponding accuracy and response time. In the case in which it is difficult to satisfy the QoS, error processing and abortion may be considered. However, this is merely an example, error processing and abortion may be performed in association with positioning for other cases in addition to the case in which it is difficult to satisfy QoS.

Subsequently, in the case of a positioning protocol defined between a base station and a location server, the positioning protocol is called LPPa in the LTE system, and operations listed below may be performed between the base station and location server.
Transmit E-CID location information
Transmit OTDOA information
Report general error states
Transmit assistance information

In addition, in the case of a positioning protocol defined between a base station and a location server, the positioning protocol is called NRPPa in the NR system, and operations listed below may be further performed between the base station and location server, in addition to the above-described operations performed by the LPPa.
Transmit positioning information
Transmit measurement information
Transmit TRP information

In the NR system, a larger number of positioning schemes may be supported, unlike the LTE system.

According to an embodiment, various positioning schemes may be supported based on positioning information transmission. For example, a base station is capable of performing positioning measurement via a positioning sound reference signal (SRS) that a UE transmits. Therefore, as the positioning information, a positioning SRS configuration and information related to activation/deactivation may be exchanged between a bases station and a location server.

According to an embodiment, measurement information transmission may be an operation of exchanging of information related to Multi-RTT, UL-TDOA, or UL-AOA, which is not supported in the LTE system, performed between the base station and the location server.

According to an embodiment, in the LTE system, positioning is performed based on a cell. However, in the NR system, positioning is performed based on a TRP and thus, TRP information transmission to exchange information related to positioning based on a TRP may be needed.

In order to measure the location of a UE in a sidelink, a subject that performs positioning-related configuration and a subject that calculates positioning may be classified as three cases as listed below.
UE (no LS)
LS (through BS)
LS (through UE)

According to an embodiment, the location server (LS) mentioned above may be a location server, a base station (BS) may be a base station such as a gNB or an eNB, and a UE may be a UE that performs transmission or reception via a sidelink. The UE that performs transmission or reception via a sidelink as described above may include a vehicle UE and a pedestrian UE. In addition, The UE that performs transmission or reception via a sidelink may include at least one among a road side unit (RSU) equipped with a UE function, an RSU equipped with a base station function, or an RSU equipped with part of a base station function and part of a UE function. In addition, the UE that performs transmission or reception via a sidelink may include a positioning reference unit (PRU) of which the location is known.

According to an embodiment, the above-described UE (no Ls) may be a sidelink UE that is not connected to a location server. The LS (through BS) is a location server which is connected to a base station. The LS (through UE) is a location server which is connected to a sidelink UE. For example, the LS (through UE) may include the case in which a location server is capable of using a UE although the UE is not located in the coverage of a base station. In this instance, the LS (through UE) may be available for a predetermined UE such as an RSU or a PRU, as opposed to a general UE. In addition, a UE connected to a location server in a sidelink may be defined as a new type of device. Only a predetermined UE that supports UE capability of connecting to a location server may perform an operation of connecting to the location server via a sidelink.

According to various embodiments of the disclosure, cases 1 to 9 in Table 1 below may be various combinations of a subject that performs positioning-related configuration and a subject that calculates positioning in order to measure the location of a UE in a sidelink. In the disclosure, a UE of which the location may need to be measured may be referred to as a target UE. A UE of which the location is known or a UE that is capable of providing a positioning signal for measuring the location of a target UE may be referred to as a positioning reference (PosRef) UE. Therefore, a PosRef UE may have location information of its own, and may provide location information of a UE together with an S-PRS. For example, a PosRef UE may be a (known location) UE of which the location is already known. A target UE and a PosRef UE may surely be replaced with other terms. For example, a PosRef UE may be referred to as an anchor UE.

According to various embodiments of the disclosure, a positioning configuration may include a UE configured scheme and a network-configured scheme.

According to an embodiment, referring to Table 1, in the case in which a positioning configuration is UE (no LS), a UE-configured scheme may be used. In the case of the UE-configured scheme, positioning configuration is available even when a UE is not located in the coverage of a network (base station).

According to an embodiment, referring to Table 1, in the case in which a positioning configuration is LS (through BS), a network-configured scheme may be used. The network-configured scheme corresponds to the case in which a UE is in the coverage of a network, and the UE may report positioning calculation and measurement information to a base station. In this instance, a location server connected to the base station measures the location of a target UE, and thus a delay due to signaling related to location measurement may be incurred. However, the location may be more accurately measured.

According to an embodiment, referring to Table 1, in the case in which a positioning configuration is LS (through UE), the positioning configuration is different from the scheme in which a UE is configured by a base station in the coverage of a network, and thus the network-configured scheme may not be used. In addition, a location server connected to a UE may provide a configuration, however, when the location server is not identified that the UE performs configuration, this may not be classified as a UE-configured scheme. However, when the location server is identified that the UE performs configuration, this may be classified as a UE-configured scheme. Therefore, LS (through UE) may be referred to as a scheme different from the UE-configured scheme or network-configured scheme.

In addition, as described above, the positioning calculation may be classified as two types, such as a UL-assisted scheme and a UL-based scheme. The case in which the positioning calculation is UL (no LS) in Table 1 may correspond to a UL-based scheme. The case in which the positioning calculation is LS (through BS) or LS (through UL) may generally correspond to a UL-assisted scheme. However, in the case in which the positioning calculation is LS (through UL) and the corresponding location server is interpreted as a UL, the LS (through UL) may be classified as a UL-based scheme.

TABLE 1

| | Positioning | Positioning |
|---|---|---|
| | configuration | calculation |
| Case 1 | UE (no LS) | UE (no LS) |
| Case 2 | UE (no LS) | LS (through BS) |
| Case 3 | UE (no LS) | LS (through UE) |
| Case 4 | LS (through BS) | UE (no LS) |
| Case 5 | LS (through BS) | LS (through BS) |
| Case 6 | LS (through BS) | LS (through UE) |
| Case 7 | LS (through UE) | UE (no LS) |
| Case 8 | LS (through UE) | LS (through BS) |
| Case 9 | LS (through UE) | LS (through UE) |

Referring to Table 1, positioning configuration information may include S-PRS configuration information. S-PRS configuration information may include at least one among S-PRS pattern information or information related to time/frequency transmission location. In addition, the positioning calculation in Table 1 may include an operation in which a UL receives an S-PRS and performs measurement based on the received S-PRS. Depending on a positioning method applied, a positioning measurement and calculation method may be changed. The measurement of location information in a sidelink may be absolute positioning that provides a two-dimensional (x, y) and three-dimensional (x, y, z) coordinate location value, or may be relative positioning that provides relative two-dimensional or three-dimensional location information based on another UE. In addition, the location information in a sidelink may be ranging information merely including one of the distance or direction from another UE. In the case in which the meaning of ranging in a sidelink includes both distance and direction information, ranging may be the same meaning as relative positioning. In addition, as a positioning method, a sidelink time difference of arrival (SL-TDOA), a sidelink angle-of-departure (SL-AOD), a sidelink multi-round trip time (SL Multi-RTT), a sidelink round trip time (SL RTT), a sidelink E-CID, a sidelink angle-of-arrival (SL-AOA) or the like may be considered.

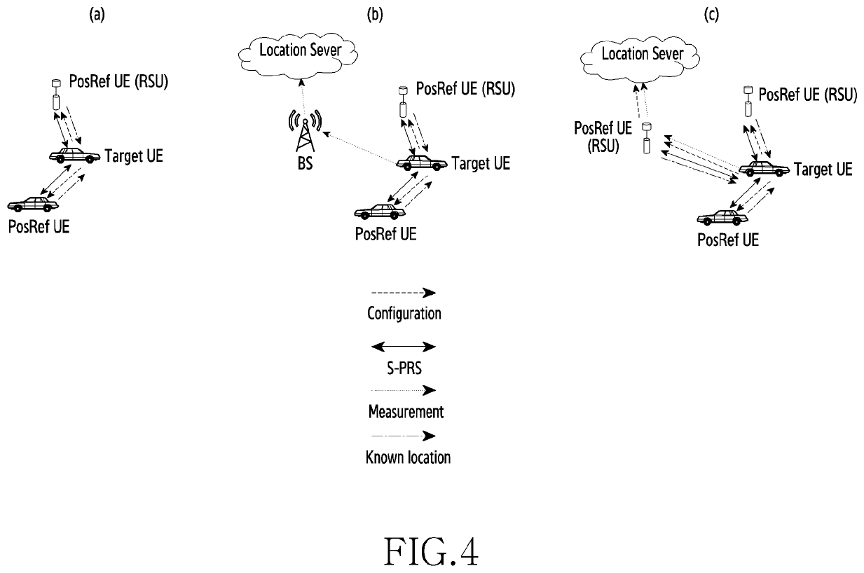

FIGS. 4 to 6 illustrate diagrams of various embodiments for measuring the location of a user equipment (UE) via a sidelink according to various embodiments of the disclosure. Specifically, FIGS. 4 to 6 illustrate diagrams of the case of calculating the location of a UE via a sidelink according to embodiments of the disclosure. However, the case of calculating the location of a UE via a sidelink in the disclosure is not limited to the cases illustrated in FIGS. 4 to 6. Referring to FIGS. 4 to 6, signaling of positioning configuration information is drawn in a normal broken line, and S-PRS transmission is drawn in a solid line. Specifically, S-PRS transmission may be performed bidirectionally or unidirectionally. Measured information for positioning or transmission of measured positioning information is drawn in a small dotted line and transmission of location information that a UE is aware of (known location) is drawn in a large dotted line.

Part (a) of FIG. 4 illustrates an example of the case in which a sidelink UE that is not connected to a location server provides a positioning configuration, and a target UE that is not connected to the location server performs positioning calculation. This may correspond to case 1 in Table 1. In this instance, the target UE may transmit indication associated with positioning-related configuration information to another UE via sidelink-based broadcast, unicast, or groupcast. In addition, the target UE may perform positioning calculation based on a received positioning signal.

Part (b) of FIG. 4 illustrates an example of the case in which a sidelink UE that is not connected to a location server provides a positioning configuration and the location server connected to a base station performs positioning calculation since a target UE is located in the coverage of a network. This may correspond to case 2 in Table 1. In this instance, the target UE may transmit indication associated with positioning-related configuration information to another UE via sidelink-based broadcast, unicast, or groupcast. In addition, the target UE may perform positioning measurement based on a received positioning signal, and may report the measured positioning information to the base station since the target UE is in the coverage of the base station. Accordingly, the corresponding measurement information is reported to the location server connected to the base station, and the location server may perform positioning calculation.

Part (c) of FIG. 4 illustrates an example of the case in which a sidelink UE that is not connected to a location server provides a positioning configuration, and the location server performs positioning calculation based on the sidelink UE connected to the location server. This may correspond to case 3 in Table 1. In this instance, a target UE may transmit indication associated with positioning-related configuration information to another UE via sidelink-based broadcast, unicast, or groupcast. In addition, the target UE may perform positioning measurement based on a received positioning signal, and may report the measured positioning information to the UE connected to the location server since the target UE is in the coverage of a sidelink with the UE connected to the location server. Although part (c) of FIG. 4 illustrates that a UE connected to a location server is a PosRef UE (RSU), as a matter of course, the UE connected to the location server may be a UE different from an RSU. Subsequently, the corresponding measurement information is reported to the location server connected to the PosRef UE (RSU), and the location server may perform positioning calculation.

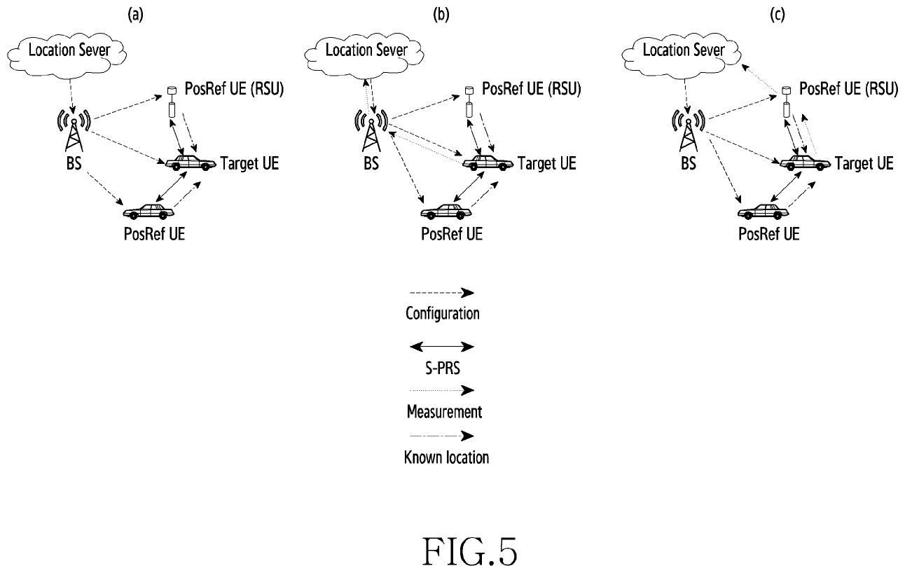

Part (a) of FIG. 5 illustrates an example of the case in which a sidelink UE is located in the coverage of a network, a location server connected to a base station provides a positioning configuration, and a target UE that is not connected to the location server performs positioning calculation. This may correspond to case 4 in Table 1. In this instance, based on a positioning protocol such as an LPP, the location server connected to the base station may provide positioning configuration information. In addition, the target UE may perform positioning calculation based on the received configuration information and positioning signal.

Part (b) of FIG. 5 illustrates an example of the case in which a sidelink UE is located in the coverage of a network, a location server connected to a base station provides a positioning configuration, and the location server connected to the base station performs positioning calculation since a target UE is located in the coverage of the network. This may correspond to case 5 in Table 1. In this instance, based on a positioning protocol such as an LPP, the location server connected to the base station may provide positioning configuration information. In addition, the target UE may perform positioning measurement based on the received configuration information and positioning signal, and may report the measured positioning information to the base station since the target UE is in the coverage of the base station. Accordingly, the corresponding measurement information is reported to the location server connected to the base station, and the location server may perform positioning calculation.

Part (c) of FIG. 5 illustrates an example of the case in which a sidelink UE is located in the coverage of a network, a location server connected to a base station provides a positioning configuration, and the location server performs positioning calculation via the sidelink UE connected to the location server. This may correspond to case 6 in Table 1. In this instance, based on a positioning protocol such as an LPP, the location server connected to the base station may provide positioning configuration information. In addition, a target UE may perform positioning measurement based on the received configuration information and positioning signal, and may report the measured positioning information to the UE connected to the location server since the target UE is in the coverage of a sidelink with the UE connected to the location server. Although part (c) of FIG. 5 illustrates that a UE connected to a location server is a PosRef UE (RSU), as a matter of course, the UE connected to the location server may also be a UE different from an RSU. Subsequently, the corresponding measurement information is reported to the location server connected to the PosRef UE (RSU), and the location server may perform positioning calculation.

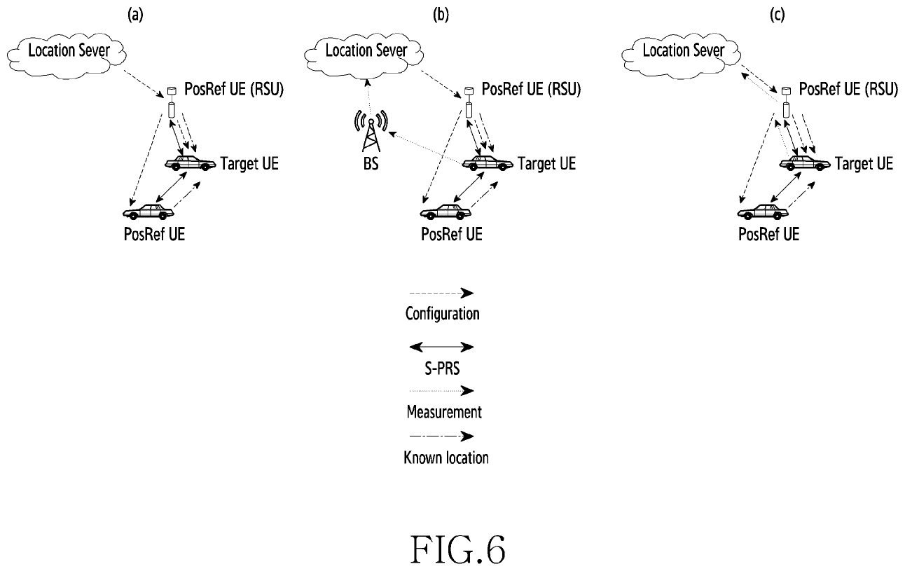

Part (a) of FIG. 6 illustrates an example of the case in which a location server provides a positioning configuration via a sidelink UE connected to the location server, and a target UE that is not connected to the location server performs positioning calculation. This may correspond to case 7 in Table 1. In this instance, based on a positioning protocol such as an LPP, the location server connected to the UE may provide positioning configuration information. In addition, the target UE may perform positioning calculation based on the received configuration information and positioning signal.

Part (b) of FIG. 6 illustrates an example of the case in which a location server provides a positioning configuration via a sidelink UE connected to the location server, and the location server connected to a base station performs positioning calculation since a target UE is located in the coverage of a network. This may correspond to case 8 in Table 1. In this instance, based on a positioning protocol such as an LPP, the location server connected to the UE may provide positioning configuration information. In addition, the target UE may perform positioning measurement based on the received configuration information and positioning signal, and may report the measured positioning information to the base station since the target UE is in the coverage of the base station. Accordingly, the corresponding measurement information is reported to the location server connected to the base station, and the location server may perform positioning calculation.

Part (c) of FIG. 6 illustrates an example of the case in which a location server provides a positioning configuration via a sidelink UE connected to the location server, and the location server performs positioning calculation via the sidelink UE connected to the location server. This may correspond to case 9 in Table 1. In this instance, based on a positioning protocol such as an LPP, the location server connected to the UE may provide positioning configuration information. In addition, a target UE may perform positioning measurement based on the received configuration information and positioning signal, and may report the measured positioning information to the UE connected to the location server since the target UE is in the coverage of a sidelink with the UE connected to the location server. Although part (c) of FIG. 6 illustrates that the UE connected to the location server is a PosRef UE (RSU), as a matter of course, the UE connected to the location server may also be a UE different from an RSU. Accordingly, the corresponding measurement information is reported to the location server connected to the PosRef UE (RSU), and the location server may perform positioning calculation.

In the following embodiment, a method of performing round trip time (RTT) using an S-PRS transmitted via a sidelink will be described. That may be referred to as an SL-RTT. However, in the various embodiments of the disclosure, the corresponding term is not limited to a predetermined term. For example, the corresponding term may be referred to as another term indicating a similar function.

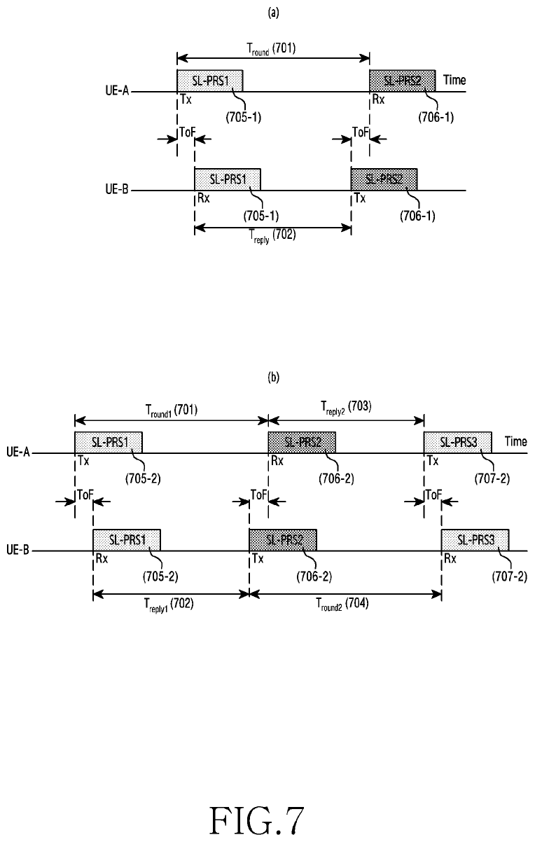

FIG. 7 illustrates a diagram of an example of performing positioning by using a round trip time (RTT) scheme according to various embodiments of the disclosure. Referring to FIG. 7, UE-A and UE-B may correspond to a target UE and a PosRef UE, respectively. However, in various embodiments of the disclosure, UE-A and UE-B may not be limited to a target UE and a PosRef UE, respectively. For example, UE-A may correspond to a PosRef UE and UE-B may correspond to a target UE.

According to an embodiment, FIG. 7 illustrates a method (single RTT) in which a target UE performs RTT with a single PosRef UE in a single pair. However, the target UE, of course, is capable of performing RTT with a plurality of PosRef UEs. For example, unlike FIG. 7, there may be a plurality of pairs between the target UE and a single PosRef UE, and this may be referred to as Multi-RTT. In order to perform absolute positioning, the target UE may need Multi-RTT. Time of flight (ToF) may be measured by using an RTT scheme, and a distance and the coordinate location of a UE may be calculated based on relational expressions such as ‘velocity=time/distance’ or ‘distance=velocity×time’ or ‘time=distance/velocity’. Here, ToF denotes time, and the velocity of light may be applied as velocity.

According to an embodiment, part (a) of FIG. 7 illustrates a single-sided RTT method. According to the single-sided RTT, UE-A transmits a positioning signal to UE-B and, in response thereto, UE-B transmits a positioning signal to UE-A, as shown in part (a) of FIG. 7, whereby RTT measurement may be performed. Specifically, UE-A may calculate Tround 701 that is a difference between a time at which UE-A transmits a positioning signal to UE-B and a time at which a positioning signal is received from UE-B. UE-B may calculate Treply 702 that is a difference between a time at which a positioning signal is received from UE-A and a time at which UE-B transmits a positioning signal to UE-A. Based thereon, ToF may be calculated according to Equation 1 as given below. In the case of Treply>>ToF, that may be formulated as given in Equation 3 below. To avoid clouding the subject matter of the disclosure, a detailed process of obtaining the equation will be omitted.

$$ToF = \frac{1}{2} ( {T}_{round} - {T}_{reply} ) \qquad [ Equation 1 ]$$

Treply information calculated by UE-B may need to be indicated to UE-A so that UE-A calculates ToF based on Equation 1. In addition, Tround information calculated by UE-A may need to be indicated to UE-B so that UE-B calculates ToF based on Equation 1.

Referring to part (a) of FIG. 7, the times that UE-A and UE-B actually measure, that is, Tround 701 and Treply 702 in Equation 1 may be changed depending on a clock source. Specifically, an oscillator that corresponds to the clock source of UE-A and UE-B may not be ideal. In addition, it may not be assumed that an identical oscillator is used. Accordingly, accuracy for each clock source (e.g., the type of oscillator) is expressed in part per millions (ppm) in Table 2. As listed in Table 2, accuracy for each clock source may have a difference for each type of an oscillator, and as the accuracy of an oscillator is higher, the price of the oscillator is higher. In addition, an accuracy may be lowered over time depending on the type of an oscillator as shown in Table 2.

TABLE 2

| | Accuracy | Aging/10 | Cost |
|---|---|---|---|
| Type | (ppm) | years (ppm) | ($) |
| Relaxation Osc. | 1000 | — | <1 |
| External XO | 10-100 | 10-20 | ~1 |
| TCXO | 2-10 | 10-20 | ~5 |
| OCXO 15-100 MHz | 0.5 | ~0.01 | ~50 |
| MEMs OCXO | 0.008 | ~0.025 | ~160 |
| Rubidium Atomic | 10⁻⁶ | 0.005 | ~1000 |
| Cesium Beam | 10⁻⁷ | — | ~3000 |

XO: crystal oscillator; TCXO: temperature-compensated crystal oscillator: OCXO: Oven-Controlled Crystal Oscillators; MEMS: microelectromechanical systems.

Therefore, in the case in which ToF is measured using a single-sided RTT method in consideration of a clock source error, that may be expressed as given in Equation 2 below.

$$ToFestimated = \frac{1}{2} ( {T}_{round} ( 1 + {e}_{A} ) - {T}_{reply} ( {e}_{B} + 1 ) ) \qquad [ Equation 2 ]$$

In Equation 2, eA and eB denote clock source errors of UE-A and UE-B, expressed in ppm, respectively. Therefore, a ToF measurement error that is obtained based in Equation 1 and Equation 2 in consideration of a clock source error may be expressed as given in Equation 3.

$$ToF - ToFestimated \approx \frac{1}{2} ( {e}_{A} - {e}_{B} ) {T}_{reply} \qquad [ Equation 3 ]$$

Equation 3 expresses that a ToF measurement error is increased based on the Treply 702 and the difference in the clock source errors between UE-A and UE-B, when single-sided RTT method is used. Specifically, the value of a ToF measurement error (ToF—ToFestimated) based on Treply 702 and a clock error (eₐ−e_{b}) is listed in Table 3 as given below.

TABLE 3

| | | Clock | | | | |
|---|---|---|---|---|---|---|
| | | error (ns) | | | | |
| T_{reply} | | 2 ppm | 5 ppm | 10 ppm | 20 ppm | 40 ppm |
| 100 | μs | 0.1 | 0.25 | 0.5 | 1 | 2 |
| 200 | μs | 0.2 | 0.5 | 1 | 2 | 4 |
| 500 | μs | 0.5 | 1.25 | 2.5 | 5 | 10 |
| 1 | ms | 1 | 2.5 | 5 | 10 | 20 |
| 2 | ms | 2 | 5 | 10 | 20 | 40 |
| 5 | ms | 5 | 12.5 | 25 | 50 | 100 |

According to Table 3, in the case in which Treply is 5 ms and a clock error (e_{A}−e_{B}) is 40 ppm, a ToF measurement error of 100 ns may be incurred. For example, that may correspond to a ToF measurement error of 30 m (e.g., the velocity of light (e.g., 300,000,000 m/s)*100*10-9 sec). In the case in which Treply is 50 ms and a clock error (e_{A}−e_{B}) is 40 ppm, a ToF measurement error of 1000 ns may be incurred. For example, that may correspond to a ToF measurement error of 300 m. As described above, in the case in which a ToF measurement error is incurred, the accuracy of positioning may be decreased. Various embodiments of the disclosure provide methods to overcome the above-describe drawbacks.

In addition to the effect of the above-described clock source error, an error caused by a delay that may be incurred during a round trip time (RTT) process may be taken into consideration. According to various embodiments of the disclosure, an error due to a corresponding delay (hereinafter delay) may be incurred by the following factors, but the disclosure is not limited thereto.
Propagation delay: the corresponding delay may be incurred when a transmitted signal is received via various obstacles.
Transmission time delay: the corresponding delay may be incurred due to various internal/external factors of a transmission UE. For example, the corresponding delay may be incurred by inter-layer message transmission, an antenna, or the like.
Receiving time delay: the corresponding delay may be incurred due to various internal/external factors of a reception UE. For example, the corresponding delay may be incurred by inter-layer message transmission, an antenna, or the like.

In the case in which a clock source error and an error caused by a delay are taken into consideration together, a ToF measurement error of Equation 3 may be replaced with Equation 4 as given below.

$$ToF - ToFestimated \approx \frac{1}{2} ( {e}_{A} - {e}_{B} ) {T}_{reply} + \frac{1}{2} {α}_{ABA} {T}_{reply} \qquad [ Equation 4 ]$$

In Equation 4, α_{ABA} is expressed in ppm and denotes an error caused by a delay that is incurred in an RTT process of UE-A->UE-B->UE-A. That may imply that a ToF measurement error may also be increased by an error caused due to a delay when the error caused due to the delay is high, in addition to by Treply 702 and a difference in clock source errors between UE-A and UE-B.

Part (b) of FIG. 7 illustrates a double-sided RTT method. According to the double-sided RTT, UE-A transmits a positioning signal to UE-B, UE-B transmits a positioning signal to UE-A in response thereto, and, subsequently, UE A transmits a positioning signal to UE-B, as shown in part (b) of FIG. 7, whereby RTT measurement may be performed. Specifically, UE-A may calculate Tround 701 that is a difference between a time at which UE-A transmits a positioning signal to UE-B and a time at which a positioning signal is received from UE-B. UE-B may calculate Treply 702 that is a difference between a time at which a positioning signal is received from UE-A and a time at which UE-B transmits a positioning signal to UE-A. Subsequently, UE-A may calculate Treply 703 that is a difference between a time at which a positioning signal is received from UE-B and a time at which UE-A transmits a positioning signal to UE-B. UE-B may calculate Tround 704 that is a difference between a time at which UE-B transmits a positioning signal to UE-A and a time at which a positioning signal is received from UE-A. Based thereon, ToF may be calculated according to Equation 5 as given below. To avoid clouding the subject matter of the disclosure, a detailed process of obtaining the equation will be omitted.

$$ToF = ( Tround 1 \times Tround 2 - Treply 1 \times Treply 2 ) \text{} / ( Tround 1 + Tround 2 + Treply 1 + Treply 2 ) \qquad [ Equation 5 ]$$

Treply1 702 and Tround2 704 information calculated by UE-B may need to be indicated to UE-A so that UE-A calculates ToF based on Equation 5. In addition, Tround1 701 and Treply2 703 information calculated by UE-A may need to be indicated to UE-B so that UE-B calculates ToF based on Equation 5. In the double-sided RTT, ToF calculation based on Equation 5 may have an additional delay when compared to single-sided RTT. Various embodiments of the disclosure do not limit an RTT method to the above-described two methods. A new RTT method may be used via various embodiments provided below.

In the case of the double-sided RTT based on Equation 5, when compared to the single-sided RTT based on Equation 1, an effect of a clock source error is minimized in each UE and the accuracy of positioning may be increased. Specifically, in the case of ToF measurement performed via the double-sided RTT method, a ToF measurement error in consideration of a clock source error may be determined as shown in Equation 6. To avoid clouding the subject matter of the disclosure, a detailed process of obtaining the equation will be omitted.

$$ToF - ToFestimated \approx \frac{1}{4} ( {e}_{A} - {e}_{B} ) ( {T}_{reply 1} - {T}_{reply 2} ) \qquad [ Equation 6 ]$$

According to Equation 6, the value of Treply1 702 and the value of Treply2 703 need to be nearly equal in order to decrease a ToF measurement error. This may be related to selection of a resource of an S-PRS in a sidelink. This will be described in detail with reference to the following embodiments associated with double-sided RTT.

In addition to the effect of the above-described clock source error, an error caused by a delay that may be incurred during an RTT process may be taken into consideration. An error causing factor associated with a delay may be understood with reference to the above description. In the case in which a clock source error and an error caused by a delay are taken into consideration together, a ToF measurement error of Equation 3 may be replaced with Equation 7 as given below. To avoid clouding the subject matter of the disclosure, a detailed process of obtaining the equation will be omitted.

$$ToF - ToFestimated \approx \frac{1}{4} ( {e}_{A} - {e}_{B} ) ( {T}_{reply 1} - {T}_{reply 2} ) + \frac{1}{4} ( {α}_{BAB} {T}_{reply 1} + {α}_{ABA} {T}_{reply 2} ) \qquad [ Equation 7 ]$$

In Equation 7, α_{ABA} is expressed in ppm and denotes an error caused by a delay that is incurred in an RTT process of UE-B->UE-A->UE-B. α_{BAB} is expressed in ppm and denotes an error caused by a delay that is incurred in an RTT process of UE-A->UE-B->UE-A. That may imply that a ToF measurement error may also be increased by an error associated with a delay and the value of Treply1 702 and the value of Treply2 703 when the error associated with the delay is high, in addition to by a difference between Treply1 702 Treply2 703 and a difference (e_{A}−e_{B}) in clock source errors between UE-A and UE-B.

In addition, in the case in which double-sided RRT illustrated in part (b) of FIG. 7 is used, when compared to the single-sided RTT method illustrated in part (a) of FIG. 7, during ToF measurement, the fact that an error is not highly affected by the value of Treply, unlike Equation 3, may be identified based on Equation 8 below.

$$ToF - ToFestimated \approx ToF ( 1 - \frac{{k}_{A} + {k}_{B}}{2} ) \qquad [ Equation 8 ]$$

k_{A} and k_{B} in Equation 8 denote a ratio of a frequency in which UE-A operates to an ideal clock frequency and a ratio of a frequency in which UE-B operates to an ideal clock frequency (e.g., a value: 0.99998 or 1.00002), respectively. In Equation 8, a clock of UE-A and a clock of UE-B may operate in a frequency that is k_{A} times greater than the ideal clock frequency and a frequency that is k_{B} times greater than the ideal clock frequency, respectively. For example, an actual measurement value obtained on the assumption of an ideal clock for the measurement value Treply of UE-A may be expressed as k_{A} Treply. An actual measurement value obtained on the assumption of an ideal clock for the measurement value Treply of UE-B may be expressed as k_{B} Treply. According to Equation 8, in the case in which double-sided RTT illustrated in part (b) of FIG. 7 is used, it is identified that an error of ToF is not highly affected by the value of Treply (Treply1 or Treply2) when ToF is measured, when compared to the single-sided RTT method provided in part (a) of FIG. 7. However, that may correspond to the case in which an error associated with a delay is not taken into consideration or the case in which the corresponding error is small. In the case in which an effect of an error incurred due to a delay is high, a ToF measurement error may be affected by the value of Treply (Treply1 or Treply2) as shown in Equation 7.

In sidelink positioning, the determination of Treply(Treply1 or Treply2) and Tround(Tround1 or Tround2) may be performed based on a result of resource selection for S-PRS transmission. In sidelink positioning, a method of selecting a resource for S-PRS transmission may be classified as a method of receiving a resource allocated from a base station (hereinafter, scheme 1) or a method of selecting a resource via sensing autonomously by a UE (hereinafter, scheme 2).

According to various embodiments of the disclosure, there is described methods of minimizing a ToF measurement error according to an RTT method applied in a sidelink. As a matter of course, the accuracy of sidelink positioning is increased as a ToF measurement error is minimized.

In addition, as a matter of course, one or more among the various embodiments of the disclosure may be combined and used. According to an embodiment, a UE that is capable of providing a positioning signal for measuring the location of a target UE may include an anchor UE. The anchor UE may include at least one among a (known location) UE of which the location is already known or an (unknown location) UE of which the location is not known. In the case in which the anchor UE is the (known location) UE of which the location is already known, the corresponding location information may be transferred to the target UE and the target UE may perform UE-based positioning. Although various embodiments of the disclosure describe methods based on RTT, the disclosure is not limited thereto and may be applied to other positioning methods, in addition to RTT.

### Embodiment 1

According to various embodiments of the disclosure, embodiment 1 provides a new RTT method that is different from an RTT method provided with reference to FIG. 7.

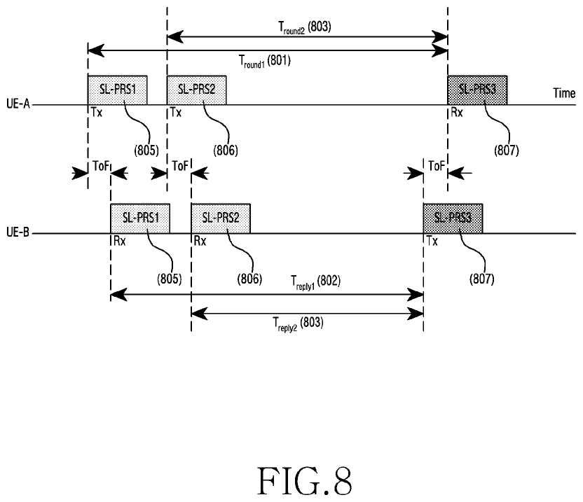

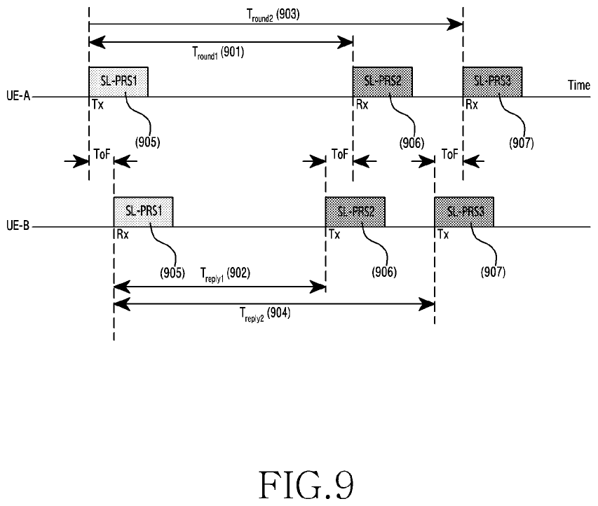

FIGS. 8 and 9 illustrate diagrams of examples of performing positioning using a new RTT scheme according to various embodiments of the disclosure. Referring to FIGS. 8 and 9, a new RTT method unlike FIG. 7 will be described.

In the case of RTT provided in part (a) of FIG. 7, an error may be incurred due to a delay that is incurred in an RTT process and a clock source when ToF is measured, and the amount of errors may be increased via selection of the value of Treply.

In the case of RTT method provided in part (b) of FIG. 7, an effect of an error caused by a clock source may be minimized. Part (b) of FIG. 7 illustrates the case in which Tround1 and Treply2 information calculated by UE-A may be indicated to UE-B, and UE-B calculates a ToF. However, Treply1 and Tround2 information calculated by UE-B may need to be indicated to UE-A so that the UE-A calculates ToF. In this instance, Tround2 information may need to be further indicated when compared to the case of part (b) of FIG. 7, and thus an additional delay may be incurred when ToF is calculated. Therefore, in the double-sided RTT method of part (b) of FIG. 7, a long delay time may be incurred when ToF is calculated, when compared to a single-sided RTT method of part (a) of FIG. 7, and a resource may need to be frequently selected and operation is inconvenient.

According to various embodiments of the disclosure, new RTT method 1 is illustrated with reference to FIG. 8. RTT method 1 may be referred to as improved single-sided RTT. However, in the disclosure, the name of RTT method 1, of course, is not limited to a predetermined name. The subject that performs sidelink positioning in FIG. 8 may be UE-A. A subject that performs positioning measures ToF, and obtains the position (e.g., distance and coordinate information) of a UE. UE-A may request a neighboring UE to perform RTT in order to perform direct positioning. Unlike the above, UE-A may be triggered by one of another UE, a base station, or a location server so as to perform positioning.

According to FIG. 8, UE-A transmits a positioning signal to UE-B consecutively two times and, in response thereto, UE-B transmits a positioning signal to UE-A, whereby RTT measurement may be performed. In the case of method 1, it is construed that a transmission order of an S-PRS transmitted by UE-A is changed when compared to RTT method provided in part (b) of FIG. 7. In part (b) of FIG. 7, RTT may be performed in an order in which UE-A transmits an S-PRS first, and subsequently, UE-A receives an S-PRS transmitted by UE-B, and then, UE-A transmits an S-PRS again. However, according to new RTT method 1, RTT may be performed in an order in which UE-A transmits an S-PRS two times first, and subsequently, receives an S-PRS transmitted by UE-B. A method of calculating ToF via the new RTT method 1 may comply with Equation 9 below. In various embodiments of the disclosure, similar to double-sided RTT of part (b) of FIG. 7, an effect of an error incurred by a clock source may be minimized according to method 1. In addition, when compared to double-sided RTT of part (b) of FIG. 7, method 1 may have an advantage as shown below.
Advantage 1: In the case in which ToF measurement is performed in UE-A, RTT method 1 may reduce a delay time when compared to double-sided RTT of part (b) of FIG. 7. Specifically, UE-B may need to perform signal transmission to UE-A two times in double-sided RTT of part (b) of FIG. 7 (e.g., in the case of transmission of an S-PRS 706, after Tround2 704 is measured, transmission is performed again), whereas UE-B performs signal transmission only once to UE-A (e.g., in the case of transmission of the S-PRS 706) in method 1.
Advantage 2: From the perspective of selection of a resource for S-PRS transmission, in the case of double-sided RTT of part (b) of FIG. 7, UE-A may transmit an S-PRS 705 and receives an S-PRS 706 from UE-B, and subsequently, may transmit an S-PRS 707. Therefore, UE-B may independently perform resource selection for transmitting the S-PRS 705 and S-PRS 707. Although resource selection for transmitting the S-PRS 705 and S-PRS 707 is not performed independently, a resource for transmitting the S-PRS 707 may need to be selected after receiving the S-PRS 706 from UE-B. Accordingly, this may need to be taken into consideration. However, in RTT method 1, UE-A may perform resource selection for transmitting an S-PRS 805 and S-PRS 806 at once. Therefore, resource selection for S-PRS transmission may be more efficiently performed.
Advantage 3: In the case of double-sided RTT of part (b) of FIG. 7, in order to decrease a ToF measurement error, the value of Treply1 702 and the value of Treply2 703 may need to be nearly equal according to Equation 6. This may be another restriction when resource selection for S-PRS transmission is performed. However, such a restriction is not given in method 1.

According to various embodiments of the disclosure, new RTT method 2 is illustrated with reference to FIG. 9. In the same manner as RTT method 1, RTT method 2 may also be referred to as improved single-sided RTT. However, in the disclosure, the name of RTT method 2, of course, is not limited to a predetermined name. Referring to FIG. 9, UE-A transmits a positioning signal to UE-B and, in response thereto, UE-B transmits a positioning signal to UE-A consecutively two times, whereby RTT measurement may be performed. In the case of RTT method 2, it is understood that a subject of transmitting a positioning signal consecutively two times is not UE-A but UE-B, when compared to RTT method 1. In the case in which UE-B transmits a positioning signal consecutively two times, specifically, an S-PRS 906 and an S-PRS 907 in FIG. 9, resource selection for transmitting the same may be performed at once. Therefore, resource selection for S-PRS transmission may be more efficiently performed. Just as the double-sided RTT of part (b) of FIG. 7, an effect of an error incurred by a clock source may be minimized. As described above, RTT method 2 may equally have the advantages of RTT method 1 described above in comparison with double-sided RTT of part (b) of FIG. 7.

In the above-described new RTT method 1 and RTT method 2, ToF may be calculated as given in Equation 9 below. In Equation 9 below, values of T_{round1}, T_{round2}, T_{reply1}, and T_{reply2} may be understood with reference to FIG. 8 and FIG. 9.

$$ToF = \frac{1}{2} ( {T}_{round 1} - δ \cdot {T}_{reply 1} ) \qquad [ Equation 9 ]$$

In the equation, δ denotes a correction factor, and δ may be calculated as shown in Equation 10 below in RTT method 1.

$$δ = \frac{{T}_{round 1} - {T}_{round 2}}{{T}_{reply 1} - {T}_{reply 2}} \qquad [ Equation 10 ]$$

In Equation 8, T_{round1}−T_{round2} denotes a difference in transmission time between S-PRS1 and S-PRS2, which is calculated by UE-A, with reference to FIG. 8. Unlike the above, T_{reply1}−T_{reply2} may denote a difference in transmission time between S-PRS1 and S-PRS2 calculated by UE-B. Therefore, a correction factor which is a rate associated therewith may be a clock drift rate (a difference in clock rate) between two UEs, A correction factor in RTT method 2 may be calculated as follows.

$$δ = \frac{{T}_{round 2} - {T}_{round 1}}{{T}_{reply 2} - {T}_{reply 1}} \qquad [ Equation 11 ]$$

In Equation 11, T_{round2}−T_{round1} denotes a difference in transmission time between S-PRS2 and S-PRS3, which is calculated by UE-A. Unlike the above, T_{reply2}−T_{reply1} may denote a difference in transmission time between S-PRS2 and S-PRS3 calculated by UE-B. Therefore, a correction factor which is a rate associated therewith may be a clock drift rate (a difference in clock rate) between two UEs, for example, it is understood that a time zone based on a clock of UE-B is synchronized with a time zone based on a clock of UE-A by applying the corresponding correction factor in Equation 9.

According to various embodiments of the disclosure, one of the above-described new RTT method 1 or RTT method 2 may be selected. In addition, according to an embodiment, two methods may be used simultaneously. Alternatively, according to an embodiment, in the case in which both methods are supported, which method is to be used may be (pre-)configured, or a selected method between the two methods may be indicated.

### Embodiment 2

According to various embodiments of the disclosure, a method of performing new RTT method 1 described in embodiment 1 will be described in detail in embodiment 2.

Referring to FIG. 8, to perform new RTT method 1, the S-PRS resource 805 and 806 that UE-A transmits to UE-B and an S-PRS resource 807 that UE-B transmits to UE-A may be selected and allocated. Selection of an S-PRS resource may be performed so as not to collide with a resource selected by a UE. Referring to FIG. 8, for ease of description, only single UE-B is illustrated but a plurality of UE-Bs may be used. In the case in which a plurality of UE-Bs is considered, a multi-RTT method may be applied and absolute positioning may be performed.

According to an embodiment, the S-PRS transmission resources 805 and 806 may be selected simultaneously. For example, when resource selection is performed, two resources may be selected simultaneously. When compared to the existing single-sided method and double-sided method, new RTT method 1 is advantageous in that few constraints exist when a resource is selected in order to reduce a ToF measurement error.

Hereinafter, a resource selection method and RTT operation in the case in which new RTT method 1 is performed will be described. According to various embodiments of the disclosure, the disclosure, of course, is not limited to the following methods. In addition, one or more among the following methods may be supported or may be used in combination. In the case in which one or more among the following methods are supported, which of the methods is to be used may be (pre-)configured or a selected method may be indicated.

### Method 1

In method 1, scheme 1 may be considered. UE-A may be assigned, by a base station, with a resource for transmitting the S-PRS 805 and 806, in order to perform ToF measurement using RTT. In order to allocate an S-PRS transmission resource to the UE by the base station, various higher layer indication methods by a location server via a DCI, Uu-RRc, and positioning protocol may be considered. According to the various embodiments of the disclosure, the corresponding indication method is not limited to a predetermined method.

The UE may indicate, to a neighboring UE, information associated with an S-PRS transmission resource allocated from the base station, when performing S-PRS transmission. SCI may be considered as the corresponding indication method. According to an embodiment, in the case in which information associated with an S-PRS transmission resource that the UE selects and reserves is indicated via SCI, the neighboring UE may identify information associated with a resource that another UE selects and reserves via sensing (e.g., decoding the SCI), and may perform scheme 2 via reference signals received power (RSRP) measurement.

In the case in which UE-A is assigned with an S-PRS transmission resource for the S-PRS 805 and 806 by the base station according to scheme 1, UE-A may transmit the S-PRS 805 and 806 to a neighboring UE via unicast, groupcast, or broadcast. Subsequently, in the case in which the neighboring UE (UE-B) is requested to perform RTT, UE-B may select a resource for transmitting the S-PRS 807 or for providing the value of Treply1 802 and Treply2 803 via the various methods as given below. As described above, herein, single UE-B or multiple UE-Bs may be used.

According to various embodiments of the disclosure, as a matter of course, the disclosure is not limited to the following methods and the methods are not limited to a predetermined method. In addition, one or more among the following methods may be supported or may be used in combination. In the case in which one or more among the following methods are supported, which of the methods is to be used may be (pre-)configured or a selected method may be indicated.

According to a first method, UE-B is assigned, by a base station, with a resource for transmitting the S-PRS 807 according to scheme 1, and may respond to an RTT request in a unicast, groupcast, or broadcast manner.

According to a second method, UE-B autonomously selects and allocates a resource for transmitting the S-PRS 807 according to scheme 2, and may respond to an RTT request in a unicast, groupcast, or broadcast manner.

According to a third method, UE-B may be assigned, directly by UE-A, with a resource for transmitting the S-PRS 807, and may respond to an RTT request in a unicast manner. When resource selection based on scheme 2 is triggered, UE-A may simultaneously select, for UE-B, the S-PRS transmission resource 807 in a resource selection window. The corresponding method may be referred to as an inter-UE coordination scheme. A detailed signaling method for inter-UE coordination may be understood with reference to embodiment 6.

According to a fourth method, UE-B may be assigned, by UE-A, with a resource for transmitting the S-PRS 807, and may respond to an RTT request in a unicast manner. In this instance, the UE (UE-A) may transfer, to UE-B, the transmission resource for the S-PRS 807 allocated by the base station according to scheme 1. When UE-A transfers, to UE-B, the transmission resource allocated by the base station, the corresponding information may use various higher layer indication methods by a location server via SCI, PC5-RRC, a sidelink MAC-CE, or a positioning protocol. According to the various embodiments of the disclosure, the corresponding indication method is not limited to a predetermined method.

### Method 2

In method 2, scheme 2 may be considered. UE-A may autonomously select and allocate a resource for transmitting the S-PRS 805 and 806, in order to perform ToF measurement using RTT. In the case in which resource selection based on scheme 2 is triggered, a UE may simultaneously select two S-PRS transmission resources 805 and 806 in a resource selection window. The information associated with the S-PRS transmission resource that the UE selects and reserves may be indicated to another UE when S-PRS transmission is performed. According to an embodiment, SCI may be considered as the corresponding indication method. In the case in which the information associated with the S-PRS transmission resource that the UE selects and reserves is indicated via SCI, a neighboring UE may identify information associated with a resource that another UE selects and reserves via sensing (e.g., decoding the SCI), and may perform scheme 2 via RSRP measurement.

In the case in which UE-A determines an S-PRS transmission resource via scheme 2, UE-A may transmit the PRS 805 and 806 to a neighboring UE via unicast, groupcast, or broadcast. Subsequently, in the case in which the neighboring UE (UE-B) is requested to perform RTT, UE-B may select a resource for transmitting the S-PRS 807 or for providing the values of Treply1 802 and Treply2 803 via various methods. As described above, herein, single UE-B or multiple UE-Bs may be used.

According to various embodiments of the disclosure, the disclosure, of course, is not limited to the following methods and the methods are not limited to a predetermined method. In addition, one or more among the following methods may be supported or may be used in combination. In the case in which one or more among the following methods are supported, which of the methods is to be used may be (pre-)configured or a selected method may be indicated.

According to a first method, UE-B is assigned, by a base station, with a resource for transmitting the S-PRS 807 according to scheme 1, and may respond to an RTT request in a unicast, groupcast, or broadcast manner.

According to a second method, UE-B autonomously selects and allocates a resource for transmitting the S-PRS 807 according to scheme 2, and may respond to an RTT request in a unicast, groupcast, or broadcast manner.

According to a third method, UE-B may be assigned, directly by UE-A, with a resource for transmitting the S-PRS 807, and may respond to an RTT request in a unicast manner. The corresponding method may be referred to as an inter-UE coordination scheme. A detailed signaling method for inter-UE coordination may be understood with reference to embodiment 6.

According to a fourth method, UE-B may be assigned, by UE-A, with a resource for transmitting the S-PRS 807, and may respond to an RTT request in a unicast manner. In this instance, the UE (UE-A) may transfer, to UE-B, the S-PRS transmission resource allocated for the S-PRS 807 by the base station according to scheme 1. When UE-A transfers, to UE-B, the transmission resource allocated by the base station, the corresponding information may be transmitted based on various higher layer indication methods by a location server via SCI, PC5-RRC, a sidelink MAC-CE, or a positioning protocol. According to the various embodiments of the disclosure, the corresponding indication method is not limited to a predetermined method.

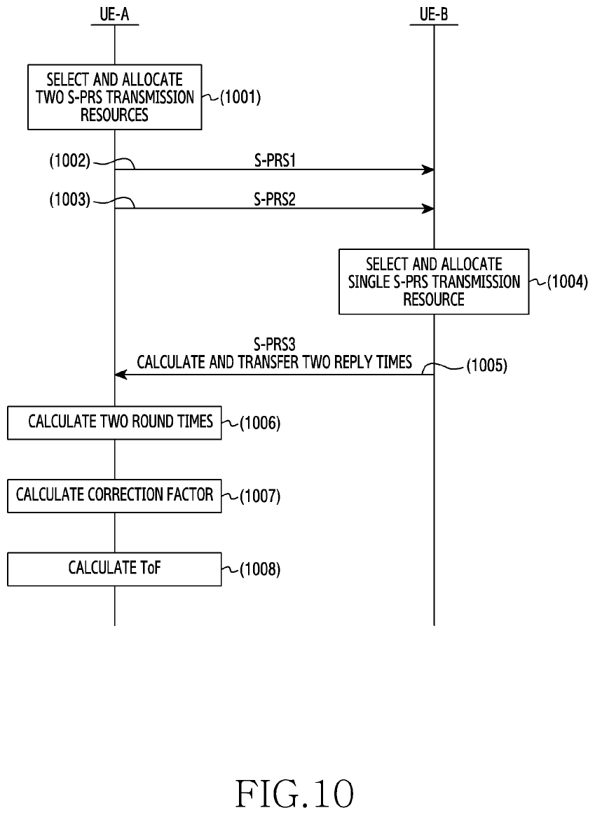

FIG. 10 illustrates a flowchart of operations for performing positioning using an RTT scheme according to various embodiments of the disclosure. FIG. 10 illustrates a procedure that performs new RTT method 1. For ease of description, UE-A and UE-B are illustrated in FIG. 10. According to various embodiments of the disclosure, this is merely an example, and the disclosure is not limited thereto. This may be a predetermined UE in the case of unicast, this may be UEs in a group in the case of groupcast, or this may not be a predetermine UE in the case of broadcast.

In operation 1001, UE-A may select two S-PRS resources. It is assumed that a resource that is located temporally earlier between the two selected resources is S-PRS1 and a resource located temporally later is S-PRS2.

In operation 1002, UE-A may transmit S-PRS1. In operation 1003, UE-A may transmit S-PRS2. UE-B may receive S-PRS1 and S-PRS2 transmitted from UE-A.

In operation 1004, UE-B may select and allocate a single S-PRS transmission resource in response to a request for performing RTT, and may transmit the same to UE-A. According to an embodiment, the request for performing RTT may be indicated by UE-A, or may be indicated by at least one of a UE different from UE-A, a base station, or a location server. According to an embodiment, in the case in which UE-A provides an indication, the corresponding indication is 1-bit information, and may be transmitted by being included in SCI (e.g., 1st SCI or 2nd SCI) when S-PRS1 and S-PRS2 are transmitted. However, in the various embodiments of the disclosure, the corresponding method is not limited thereto. According to an embodiment, as another method, various higher layer indication methods by a location server via a PSSCH, a sidelink MAC-CE, PC5-RRC, or a positioning protocol may be considered. The resource selected in operation 1004 is assumed to be S-PRS3.

In operation 1005, UE-B may calculate a difference between a time at which S-PRS3 is transmitted and a time at which S-PRS1 and S-PRS2 are received, while transmitting S-PRS3 to UE-A. The difference between the time at which S-PRS1 is received and the time at which S-PRS3 is transmitted may be expressed as Treply1, and the difference between the time at which S-PRS2 is received and the time at which S-PRS3 is transmitted may be expressed as Treply2. A detailed description thereof is provided with reference to embodiment 4. According to an embodiment, UE-B may provide values corresponding to Treply1 and Treply2 together with transmission of S-PRS3 in operation 1005. According to an embodiment, indication of the corresponding information may be performed in various methods. For example, various methods such as SCI (e.g., 1st SCI and 2nd SCI), a PSSCH, a sidelink MAC-CE, and the like may be considered. According to an embodiment, corresponding values may not be provided together with transmission of S-PRS3. In this instance, various higher layer indication methods by a location server via SCI (e.g., 1st SCI and 2nd SCI), a PSSCH, a sidelink MAC-CE, PC5-RRC, or a positioning protocol may be considered. The disclosure may not limit the above-described methods to a predetermined indication method.

In operation 1006, UE-A may receive S-PRS3, and may calculate two round times. Tround1 that is a first round time may be calculated to be a difference between a time at which S-PRS1 is transmitted in operation 1002 and a time at which S-PRS3 is received in operation 1005. Tround2 that is a second round time may be calculated to be a difference between a time at which S-PRS2 is transmitted in operation 1003 and a time at which S-PRS3 is received in operation 1005.

In operation 1007, UE-A may calculate a correction factor based on Equation 10.

In operation 1008, UE-A may measure ToF in Equation 9.

### Embodiment 3

According to various embodiments of the disclosure, a method of performing new RTT method 2 described in embodiment 1 is described in detail in embodiment 3.

Referring to FIG. 9, to perform new RTT method 2, an S-PRS resource 905 that UE-A transmits to UE-B and the S-PRS resources 906 and 907 that UE-B transmits to UE-A may be selected and allocated. In FIG. 9, for ease of description, only single UE-B is illustrated but a plurality of UE-Bs may be used. In the case in which a plurality of UE-Bs are considered, a multi-RTT method may be applied and absolute positioning may be performed.

According to an embodiment, the S-PRS transmission resources 906 and 907 may be selected simultaneously. For example, when resource selection is performed, two resources may be selected simultaneously. The S-PRS transmission resource 905 may also be selected not to collide a resource selected by another UE. When compared to the existing single-sided method and double-sided method, new RTT method 2 is advantageous in that few constraints exist when a resource is selected in order to reduce a ToF measurement error.

Hereinafter, a resource selection method and RTT operation in the case in which new RTT method 2 is performed will be described. According to various embodiments of the disclosure, the disclosure is not limited to the following methods. In addition, one or more among the following methods may be supported or may be used in combination. In the case in which one or more among the following methods are supported, which of the methods is to be used may be (pre-)configured or a selected method may be indicated.

### Method 1

In method 1, scheme 1 may be considered. UE-A is assigned, by a base station, with a resource for transmitting the S-PRS 905 in order to perform ToF measurement using RTT. In order to allocate an S-PRS transmission resource to the UE by the base station, various higher layer indication methods by a location server via a DCI, Uu-RRc, and a positioning protocol may be considered. According to the various embodiments of the disclosure, the corresponding indication method is not limited to a predetermined method.

The UE may indicate, to a neighboring UE, information associated with an S-PRS transmission resource allocated from the base station, when performing S-PRS transmission. SCI may be considered as the corresponding indication method. According to an embodiment, in the cases in which information associated with an S-PRS transmission resource that the UE selects and reserves is indicated via SCI, the neighboring UE may identify information associated with a resource that another UE selects and reserves via sensing (e.g., decoding the SCI), and may perform scheme 2 via RSRP measurement.

In the case in which UE-A is assigned with a transmission resource for the S-PRS 905 by a base station via scheme 1, UE-A may transmit the S-PRS 905 to a neighboring UE via unicast, groupcast, or broadcast. Subsequently, in the case in which a neighboring UE (UE-B) is requested to perform RTT, UE-B may select a resource for transmitting the S-PRS 906 and 907 or for providing the value of Treply1 902 and the value of Treply2 904 via the various methods as given below. As described above, herein, single UE-B or multiple UE-Bs may be used.

According to various embodiments of the disclosure, the disclosure, of course, is not limited to the following methods and the methods are not limited to a predetermined method. In addition, one or more among the following methods may be supported or may be used in combination. In the case in which one or more among the following methods are supported, which of the methods is to be used may be (pre-)configured or a selected method may be indicated.

According to a first method, UE-B is assigned with, by a base station, a resource for transmitting the S-PRS 906 and 907 according to scheme 1, and may respond to an RTT request in a unicast, groupcast, or broadcast manner.

According to a second method, UE-B autonomously selects and allocates a resource for transmitting the S-PRS 906 and 907 according to scheme 2, and may respond to an RTT request in a unicast, groupcast, or broadcast manner. In the case in which resource selection based on scheme 2 is triggered, a UE may simultaneously select two S-PRS transmission resources 906 and 907 in a resource selection window.

According to a third method, UE-B may be assigned with, directly by UE-A, resources for transmitting the S-PRS 906 and 907, and may respond to an RTT request in a unicast manner. In the case in which resource selection based on scheme 2 is triggered, UE-A may simultaneously select two S-PRS transmission resources 906 and 907 for UE-B in a resource selection window. The corresponding method may be referred to as an inter-UE coordination scheme. A detailed signaling method for inter-UE coordination may be understood with reference to embodiment 6.

According to a fourth method, UE-B may be assigned with, by UE-A, a resource for transmitting the S-PRS 906 and 907, and may respond to an RTT request in a unicast manner. In this instance, the UE (UE-A) may transfer, to UE-B, the resource for transmitting the S-PRS 906 and 907 allocated by the base station according to scheme 1. When UE-A transfers, to UE-B, the transmission resource allocated by the base station, the corresponding information may use various higher layer indication methods by a location server via SCI, PC5-RRC, a sidelink MAC-CE, or a positioning protocol. According to the various embodiments of the disclosure, the corresponding indication method is not limited to a predetermined method.

### Method 2

In method 2, scheme 2 may be considered. UE-A may autonomously select and allocate a resource for transmitting the S-PRS 905 in order to perform ToF measurement using RTT. The information associated with the S-PRS transmission resource that the UE selects and reserves may be indicated to a neighboring UE when S-PRS transmission is performed. According to an embodiment, SCI may be considered as the corresponding indication method. In the case in which the information associated with the S-PRS transmission resource that the UE selects and reserves is indicated via SCI, the neighboring UE may identify information associated with a resource that another UE selects and reserves via sensing (e.g., decoding the SCI), and may perform scheme 2 via RSRP measurement.

In the case in which UE-A determines an S-PRS transmission resource via scheme 2, UE-A may transmit the PRS 905 to a neighboring UE via unicast, groupcast, or broadcast. Subsequently, in the case in which the neighboring UE (UE-B) is requested to perform RTT, UE-B may select a resource for transmitting the S-PRS 906 and 907 or for providing the value of Treply1 902 and the value of Treply2 904 via various methods. As described above, herein, single UE-B or multiple UE-Bs may be used.

According to various embodiments of the disclosure, the disclosure, of course, is not limited to the following methods and the methods are not limited to a predetermined method. In addition, one or more among the following methods may be supported or may be used in combination. In the case in which one or more among the following methods are supported, which of the methods is to be used may be (pre-)configured or a selected method may be indicated.

According to a first method, UE-B is assigned with, by a base station, a resource for transmitting the S-PRS 906 and 907 according to scheme 1, and may respond to an RTT request in a unicast, groupcast, or broadcast manner.

According to a second method, UE-B autonomously selects and allocates a resource for transmitting the S-PRS 906 and 907 according to scheme 2, and may respond to an RTT request in a unicast, groupcast, or broadcast manner. In the case in which resource selection based on scheme 2 is triggered, a UE may simultaneously select two S-PRS transmission resources 906 and 907 in a resource selection window.

According to a third method, UE-B may be assigned with, directly by UE-A, resources for transmitting the S-PRS 906 and 907, and may respond to an RTT request in a unicast manner. In the case in which resource selection based on scheme 2 is triggered, UE-A may simultaneously select two S-PRS transmission resources 906 and 907 for UE-B in a resource selection window. The corresponding method may also be referred to as an inter-UE coordination scheme. A detailed signaling method for inter-UE coordination may be understood with reference to embodiment 6.

According to a fourth method, UE-B may be assigned with, by UE-A, a resource for transmitting the S-PRS 906 and 907, and may respond to an RTT request in a unicast manner. In this instance, the UE (UE-A) may transfer, to UE-B, the resource for transmitting the S-PRS 906 and 907 allocated by the base station according to scheme 1. When UE-A transfers, to UE-B, the transmission resource allocated by the base station, the corresponding information may be transmitted based on various higher layer indication methods by a location server via SCI, PC5-RRC, a sidelink MAC-CE, or a positioning protocol. According to the various embodiments of the disclosure, the corresponding indication method is not limited to a predetermined method.

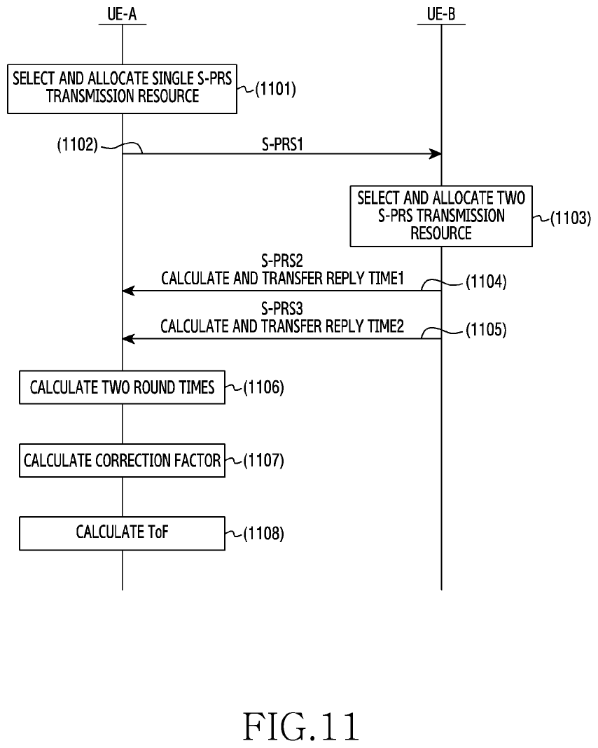

FIG. 11 illustrates a flowchart of operations for performing positioning using another RTT scheme according to various embodiments of the disclosure. FIG. 11 illustrates a procedure that performs new RTT method 2. For ease of description, UE-A and UE-B are illustrated in FIG. 11. According to various embodiments of the disclosure, this is merely an example, and the disclosure is not limited thereto. This may be a predetermined UE in the case of unicast, this may be UEs in a group in the case of groupcast, or this may not be a predetermine UE in the case of broadcast.

In operation 1101, UE-A may select a single S-PRS resource. The resource selected in operation 1101 may be assumed to be S-PRS1.

In operation 1102, UE-A may transmit S-PRS1 to UE-B. Subsequently, UE-B may receive S-PRS1 transmitted from UE-A.

Subsequently, in operation 1103, UE-B may select and allocate two S-PRS transmission resources in response to a request for performing RTT, and may transmit the same to UE-A. According to an embodiment, the request for performing RTT may be indicated by UE-A, or may be indicated by at least one of a UE different from UE-A, a base station, or a location server. According to an embodiment, in the case in which UE-A provides an indication, the corresponding indication is 1-bit information, and may be transmitted by being included in SCI (e.g., 1st SCI or 2nd SCI) when S-PRS1 is transmitted. However, in the various embodiments of the disclosure, the corresponding method is not limited thereto. According to an embodiment, as another method, various higher layer indication methods by a location server via a PSSCH, a sidelink MAC-CE, PC5-RRC, or a positioning protocol may be considered. According to an embodiment, in operation 1103, a resource that is located temporally earlier between two selected resources is assumed to be S-PRS2, and a resource that is located later is assumed to be S-PRS3.

In operation 1104, UE-A may transmit S-PRS2. In operation 1105, UE-A may transmit S-PRS3. In operation 1104, UE-B may calculate Treply1 that is a difference between a time at which S-PRS1 is received and a time at which S-PRS2 is transmitted, while transmitting S-PRS2 to UE-A. In operation 1105, UE-B may calculate Treply2 that is a difference between a time at which S-PRS1 is received and a time at which S-PRS3 is transmitted, while transmitting S-PRS3 to UE-A. A detailed description thereof is provided with reference to embodiment 4. According to an embodiment, UE-B may provide values corresponding to Treply1 and Treply2, respectively, together with transmission of an S-PRS in operation 1104 or operation 1105. According to an embodiment, indication of the corresponding information may be performed in various methods. For example, various methods such as SCI (e.g., 1st SCI and 2nd SCI), a PSSCH, a sidelink MAC-CE, and the like may be considered. According to an embodiment, corresponding values may not be provided together with transmission of an S-PRS (e.g., S-PRS2 and S-PRS3). In this instance, various higher layer indication methods by a location server via SCI (e.g., 1st SCI and 2nd SCI), a PSSCH, a sidelink MAC-CE, PC5-RRC, or a positioning protocol may be considered. The disclosure does not limit the above-described methods to a predetermined indication method.

In operation 1106, UE-A may receive S-PRS2 and S-PRS3, and may calculate two round times. Tround1 that is a first round time may be calculated to be a difference between a time at which S-PRS1 is transmitted in operation 1102 and a time at which S-PRS2 is received in operation 1104. Tround2 that is a second round time may be calculated to be a difference between a time at which S-PRS1 is transmitted in operation 1102 and a time at which S-PRS3 is received in operation 1105.

In operation 1107, UE-A may calculate a correction factor based on Equation 11.

In operation 1108, UE-A may measure ToF in Equation 9.

### Embodiment 4

Embodiment 4 describes a method of calculating and indicating values corresponding to Treply (e.g., Treply1 or Treply2) and Tround (e.g., Tround1 or Tround2) in the above-described RTT method. The above-described RTT method may include single-sided RTT, double-sided RTT, or both RTT method 1 and RTT method 2 proposed in embodiment 1. Treply may be referred to as a difference (e.g., Rx-Tx time difference) in time between a received S-PRS signal and a transmitted S-PRS signal. Tround may be referred to as a difference (e.g., Tx-Rx time difference) in time between a transmitted S-PRS signal and a received S-PRS signal. However, in the disclosure, the values corresponding to Treply (Treply1 or Treply2) and Tround (Tround1 or Tround2) are not limited to a predetermined name.

Referring to FIG. 7 to FIG. 9, in the case of values corresponding to Treply (Treply1 or Treply2) and Tround (Tround1 or Tround2), a difference in time with a time at which an S-PRS is received may be higher than a time value corresponding to a plurality of slots, depending on the point in time at which an S-PRS resource is actually selected and transmitted. In the disclosure, in the case in which inter-UE S-PRS transmission or reception is performed on the assumption of a system in which UEs are synchronized well, it is assumed that a difference in time in units of slots in which an S-PRS is transmitted or received between UEs is calculatable. For example, referring to part (a) of FIG. 7, it is assumed that UE-B receives an S-PRS 705-2 at 0 ns in slot #0, and transmits an S-PRS 706-1 at 3 ns in slot #5. In this instance, a value corresponding to the actual Treply 702 may be a value corresponding to 5 slots+3 ns (here, the length of a slot may be changed depending on numerology based on subcarrier spacing (SCS). For example, in the case of a subcarrier of 15 kHz, that may be a value corresponding to 1 slot=1 ms). Therefore, when an S-PRS 706-1 is received, UE-A may identify, from 5 slot+3 ns that is the value corresponding to Treply 702, 5 slots corresponding to the difference in time in units of slots in which transmission or reception of an S-PRS is performed between UEs. Therefore, when indicating the value corresponding Treply 702 to UE-B, UE-A may indicate only a value corresponding to 3 ns in 5 slot+3 ns that is the value corresponding to Treply 702.

According to an embodiment, the disclosure is not limited to the above-described example, there may be an example on the assumption that a system in which UEs are not synchronized when transmission of an S-PRS is performed.

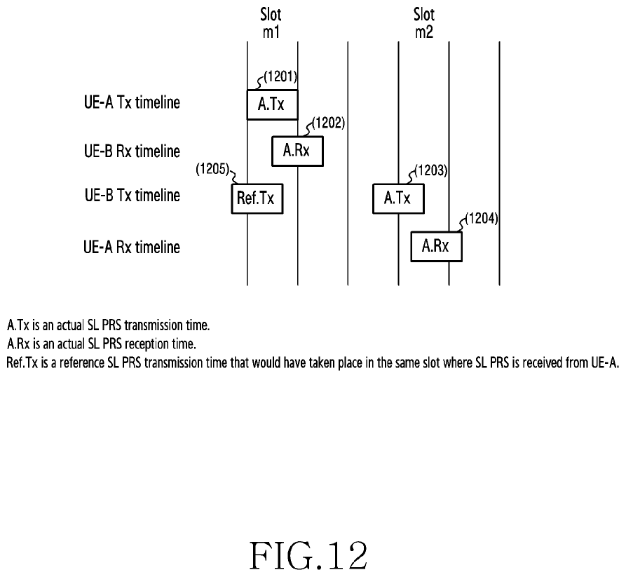

FIG. 12 illustrates a diagram of an example of a difference in time between a received S-PRS signal and a transmitted S-PRS signal according to various embodiments of the disclosure. Specifically, FIG. 12 illustrates a diagram of an example of a difference in time (e.g., Rx-Tx time difference) between a received S-PRS signal and a transmitted S-PRS signal according to various embodiments of the disclosure.

FIG. 12 illustrates the case in which UE-A transmits an S-PRS in an area 1201, and UE-B receives the S-PRS transmitted by UE-A in an area 1202. In addition, FIG. 12 illustrates that UE-B transmits an S-PRS in an area 1203, and UE-A receives the S-PRS transmitted by UE-B in an area 1204. An Rx-Tx time difference that is a difference between a time at which UE-B receives an S-PRS in the area 1202 and a time at which an S-PRS is transmitted in the area 1203 may be calculated based on a reference time of an area 1205. Here, actual S-PRS transmission by UE-B is performed in the area 1203 that is the point in time corresponding to slot m2. In this instance, the reference time in the area 1205 may be a time obtained by changing the point in time corresponding to slot m2 by using, as a reference, slot m1 corresponding to the area 1202 that is the point in time at which the S-PRS is received from UE-A. Therefore, the Rx-Tx time difference may be calculated based on a time obtained by subtracting the reference time from the time at which the S-PRS is received from another UE. Here, the reference time may be a value obtained by calculating the point in time at which the UE transmits an S-PRS by using, as a reference, a slot in which an S-PRS is received from another UE.

In the disclosure, indication of values corresponding to Treply (Treply1 or Treply2) and Tround (Tround1 or Tround2) may be values in the range of −985024·Tc to 985024·Tc (e.g., approximately 1 msec) (However, the values corresponding to Treply (Treply1 or Treply2) and Tround (Tround1 or Tround2) may be values significantly higher than an indicated value). Herein, T_{c}=1/(Δfₘₐₓ·N_{f}), Δfₘₐₓ=480·10³ Hz, and N_{f}=4096. Resolution may be X·T_{c}. That may be an integer value such as X=1, 2, . . . or the like, and is not limited to a predetermined value in the disclosure.

According to an embodiment, various methods that provide a value corresponding to Treply (Treply1 or Treply2) will be described with reference to FIG. 10 and FIG. 11 in the case in which RTT method 1 and RTT method 2 proposed in FIG. 8 and FIG. 9 are used. According to various embodiments of the disclosure, to provide information associated with Treply (Treply1 or Treply2), various methods as described below will be taken into consideration.
Method 1: Information associated with both Treply1 and Treply2 may be provided.
   For example, in RTT method 1 of FIG. 8, information associated with both Treply1 and Treply2 may be provided together when the S-PRS3 807 is transmitted.
   For example, in RTT method 2 of FIG. 9, information associated with Treply1 may be provided together when the S-PRS2 906 is transmitted, and Treply2 may be provided together when the S-PRS3 907 is transmitted.
   For example, in RTT method 2 of FIG. 9, information associated with both Treply1 and Treply2 may be provided together when the S-PRS3 907 is transmitted. For example, in the case in which the S-PRS2 906 is transmitted, Treply information may not be provided.
Method 2: Only information associated with Treply1 may be provided.
   Method 2 may be applied when a difference in transmission time between the S-PRS1 805 and the S-PRS2 806 in FIG. 8 is significantly small. Alternatively, that may be applied when a difference in transmission time between the S-PRS2 906 and S-PRS3 907 in FIG. 9 is significantly small. In these cases, it is assumed to be Treply2=Treply1, on the assumption that a difference in channel delay time is hardly incurred when two S-PRSs are transmitted.
   For example, in RTT method 1 of FIG. 8, only information associated with Treply1 may be provided when the S-PRS3 807 is transmitted.
   For example, in RTT method 2 of FIG. 9, only information associated with Treply1 may be provided when the S-PRS2 906 is transmitted. For example, in the case in which the S-PRS3 907 is transmitted, Treply information may not be provided.
   For example, in RTT method 2 of FIG. 9, only information associated with Treply1 may be provided when the S-PRS3 907 is transmitted. For example, in the case in which the S-PRS2 906 is transmitted, Treply information may not be provided.

In the above-described method 1 and method 2, an example in which information associated with Treply1 or Treply2 is transmitted together when an SL-PRS is transmitted has been described, the disclosure is not limited thereto. According to an embodiment, in the case in which information associated with Treply1 or Treply2 is provided together when an SL-PRS is transmitted, various methods such as SCI (e.g., 1st SCI and 2nd SCI), a PSSCH, or a sidelink MAC-CE, or the like may be considered. According to an embodiment, information associated with Treply1 or Treply2 may not be provided together with S-PRS transmission. In this instance, various higher layer indication methods by a location server via SCI (e.g., 1st SCI and 2nd SCI), a PSSCH, a sidelink MAC-CE, PC5-RRC, or a positioning protocol may be considered.

### Embodiment 4-2

Embodiment 4-2 additionally describes a method of calculating and indicating values corresponding to Treply (e.g., Treply1 or Treply2) and Tround (e.g., Tround1 or Tround2) in the above-described RTT method. According to various embodiments of the disclosure, the above-described RTT method may include part of, or a combination of single-sided RTT, double-sided RTT, or RTT method 1 and RTT method 2 proposed in embodiment 1.

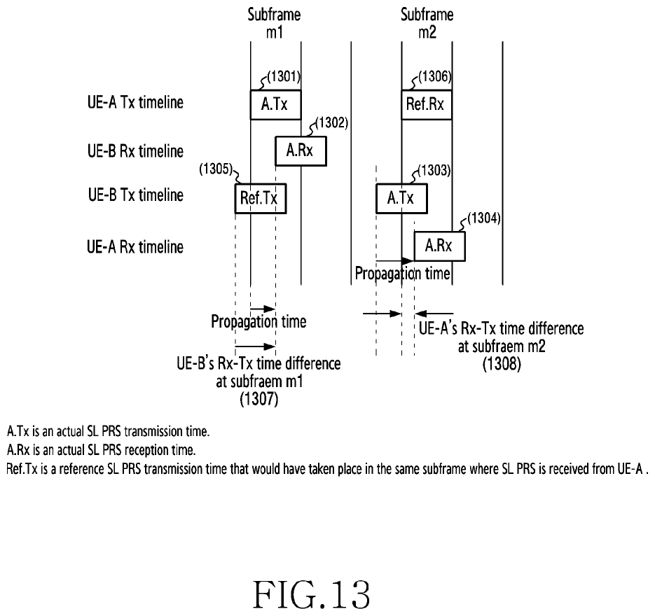

FIG. 13 illustrates a diagram of another example of a difference in time between a received S-PRS signal and a transmitted S-PRS signal according to various embodiments of the disclosure. Specifically, FIG. 13 illustrates a diagram of an example of a difference in time (e.g., Rx-Tx time difference) between a received S-PRS signal and a transmitted S-PRS signal according to various embodiments of the disclosure. According to an embodiment, FIG. 12 illustrates an example of the above-described difference in time based on a slot in which a sidelink signal is transmitted. Unlike the FIG. 12, FIG. 13 illustrates an example of a difference in time based on a subframe in which a sidelink signal is transmitted.

FIG. 13 illustrates the case in which UE-A transmits an S-PRS in an area 1301, and UE-B receives the S-PRS transmitted by UE-A in an area 1302. In addition, FIG. 13 illustrates that UE-B transmits an S-PRS in an area 1303, and UE-A receives the S-PRS transmitted by UE-B in an area 1304. An Rx-Tx time difference that is a difference between a time at which UE-B receives an S-PRS in the area 1302 and a time at which the UE-B transmits an S-PRS in the area 1303 may be calculated based on a reference time in an area 1305. Here, actual S-PRS transmission by UE-B is performed in the area 1303 that is the point in time corresponding to sidelink subframe m2. In this instance, the reference time in the area 1305 may be a time obtained by changing the point in time corresponding to sidelink subframe m2 based on sidelink subframe m1 corresponding to the area 1302 that is the point in time at which the S-PRS is received from UE-A. Therefore, an Rx-Tx time difference 1307 calculated by UE-B may be calculated based on a time obtained by subtracting the reference time from a time at which an S-PRS is received from another UE. Similarly, accordingly, an Rx-Tx time difference 1308 calculated by UE-A may be calculated based on a time obtained by subtracting the reference time from a time at which an S-PRS is received from another UE. Here, the reference time may be a value obtained by calculating the point in time at which the UE transmits an S-PRS by using, as a reference, a sidelink subframe in which an S-PRS is received from another UE.

More specifically, according to the description with reference to FIG. 13, an Rx-Tx time difference in a sidelink may be defined as given in Table 4-1 to Table 4-3 below. However, it should be construed that the disclosure is not limited to only the following definitions.

TABLE 4-1
The SL-PRS based Rx − Tx time difference is defined as T_{UE-RX} − T_{UE-RX}
Where:
T_{UE-RX} is the UE received timing of sidelink subframe #i from a UE,
defined by the first detected path in time.
T_{UE-TX} is the UE transmit timing of sidelink subframe #i corresponding to
the subframe #i received from the UE.

TABLE 4-2
The SL-PRS Rx − Tx time difference is defined as T_{UE-RX} − T_{UE-TX}
Where:
T_{UE-RX} is the UE received timing of sidelink subframe #i containing
SL-PRS from a UE, defined by the first detected path in time.
T_{UE-TX} is the UE transmit timing of sidelink subframe #j that is
closest in time to the subframe #i received from the UE.
Note: subframe #j can be subframe #i

TABLE 4-3
The SL-PRS Rx − Tx time difference is defined as T_{UE-RX} − T_{UE-TX}
Where:
T_{UE-RX} is the UE received timing of sidelink subframe #i containing
SL-PRS from a UE, defined by the first detected path in time.
T_{UE-TX} is the UE transmit timing of sidelink subframe #i which is
the same subframe received SL-PRS from the UE.

In the disclosure, indication of values corresponding to Treply (Treply1 or Treply2) and Tround (Tround1 or Tround2) may be values in the range of −985024Tc to 985024·Tc (e.g., approximately 1 msec) (However, the values corresponding to Treply (Treply1 or Treply2) and Tround (Tround1 or Tround2) may be values significantly higher than an indicated value). Herein, T_{c}=1/(Δfₘₐₓ·N_{f}), Δfₘₐₓ=480·10³ Hz, and N_{f}=4096. Resolution may be X·T_{c}. That may be an integer value such as X=1, 2, . . . or the like, and is not limited to a predetermined value in the disclosure.

In the case in which an Rx-Tx time difference in a sidelink is calculated based on the times at which an S-PRS is actually received and transmitted, unlike the definitions in Table 4, that may be defined as shown in Table 5-1 to Table 5-3 below.

TABLE 5-1
The SL-PRS based Rx − Tx time difference is defined as T_{UE-RX} − T_{UE-TX}
Where:
T_{UE-RX} is the actual UE received timing of sidelink subframe #i from a
UE, defined by the first detected path in time.
T_{UE-TX} is the actual UE transmit timing of sidelink subframe #j.
subframe #i and #j can be same or differenent.

TABLE 5-2
The SL-PRS Rx − Tx time difference is defined as T_{UE-RX} − T_{UE-TX}
Where:
T_{UE-RX} is the UE received timing of sidelink subframe #i from
another UE, defined by the first detected path in time.
T_{UE-TX} is the UE transmit timing of sidelink subframe #j in
which the UE transmits SL-PRS

As defined in Table 5-1 and Table 5-2, the range of values indicating Treply (Treply1 or Treply2) and Tround (Tround1 or Tround2) may exceed the range of −985024·Tc to 985024·Tc (e.g., approximately 1 msec). To make the same fall within the range of 1 msec, a method of Table 5-3 below may be used.

TABLE 5-3
The SL-PRS Rx − Tx time difference is defined as as mod(T_{UE-RX} −
T_{UE-TX} + 0.5 ms, 1 ms) − 0.5 ms
Where:
T_{UE-RX} is the UE received timing of sidelink subframe #i from
another UE, defined by the first detected path in time.
T_{UE-TX} is the UE transmit timing of sidelink subframe #j in
which the UE transmits SL-PRS

In the case in which both the method given in Table 4 (Table 4-1 to Table 4-3) and the method given in Table 5 (Table 5-1 to Table 5-3) are supported, UEs may need to mutually understand a method to be used for calculating an Rx-Tx time difference. In this instance, the corresponding method may be configured and indicated via various methods. Specifically, the used method may be (pre-)configured, or may be indicated via a higher layer signal according to a positioning protocol. A sidelink positioning protocol may be referred to as a sidelink positioning protocol (SLPP). The indication via a higher layer signal may be indication via a sidelink MAC-CE or PC5-RRC. Unlike the above, a method of providing indication via a lower signal may be considered. In this instance, the corresponding method may be indicated via SCI (e.g., in the case in which 1st SCI or 2nd SCI, or 2stage SCI is supported).

### Embodiment 5

Embodiment 5 describes a method of determining an RTT method. The above-described RTT method may include single-sided RTT, double-sided RTT, or RTT method 1 and RTT method 2 proposed in embodiment 1. In this instance, RTT methods may be classified as follows.
Capability 1: single-sided RTT (referring to part (a) of FIG. 7)
Capability 2: RTT method 1 (referring to FIG. 8), RTT method 2 (referring to FIG. 9)
Capability 3: double-sided RTT (referring to part (b) of FIG. 7)

As described above, there is the purpose of classifying capabilities. Single-sided RTT is the simplest method but an error may be incurred when ToF is measured due to an effect of an error incurred by a clock source. In the case of RTT method 1 or RTT method 2, complexity may be higher than that of single-sided RTT, but an effect of an error incurred by a clock source may be minimized. Double-sided RTT may be considered as the most complex method, but an effect of an error incurred by a clock source may be minimized.

In the case in which two RTT methods are employed, the following configurations may be considered.
Configuration 1: single-sided RTT+RTT method 1
Configuration 2: single-sided RTT+RTT method 2
Configuration 3: single-sided RTT+double-sided RTT

In the case in which three RTT methods are employed, the following configurations may be considered.
Configuration 1: single-sided RTT+RTT method 1+RTT method 2
Configuration 2: single-sided RTT+RTT method 1+double-sided RTT
Configuration 3: single-sided RTT+RTT method 2+double-sided RTT

In the case in which four RTT methods are employed, the following configurations may be considered.
Configuration 1: single-sided RTT+RTT method 1+RTT method 2+double-sided RTT

As described above, various RTT methods may be supported in various configurations.

Therefore, in the case in which various RTT methods are actually supported, a corresponding capability may be provided, based on classification of capabilities, to at least one of another UE, a base station, or a location server according to an RTT method supported by a UE. Not to mention that, depending on an RTT method supported, the number of capabilities may be increased or reduced.

In the case in which one or more capabilities are supported, a method to be used among RTT methods supported may need to be determined. After the determination is performed and UEs mutually understand a method to be used, positioning may be performed without difficulty. Following two methods for performing the determination may be considered. According to various embodiments of the disclosure, as a matter of course, the disclosure is not limited to the following methods. For example, both method 1 or method 2 may be used in combination.
Method 1: determined by a target UE (a UE that performs positioning management)
   Method 1-1: explicit signaling
   Method 1-2: implicit signaling
Method 2: determined by an anchor UE (a UE that provides a positioning signal and information to a target UE)
   Method 2-1: explicit signaling
   Method 2-2: explicit signaling

In the case of above-described method 1-1, various higher layer indication methods by a location server via SCI (e.g., 1st SCI and 2nd SCI), a PSSCH, a sidelink MAC-CE, PC5-RRC, or a positioning protocol may be considered. For example, in the case in which only single-sided RTT and double-sided RTT are supported, corresponding information is 1-bit information that may indicate which method is to be used between single-sided RTT or double-sided RTT. For example, in the case in which only single-sided RTT and RTT method 2 are supported, corresponding information is 1-bit information that may indicate which method is to be used between single-sided RTT or RTT method 2.

The above-described method 1-2 may be useful, in the case in which only single-sided RTT and RTT method 1 are supported. In the case in which single-sided RTT is used, a target UE (UE-A in part (a) of FIG. 7 and FIG. 8) may select only a single resource, and may indicate information associated with the corresponding selected resource via SCI. In the case in which RTT method 1 is used, a target UE may select two resources, and may indicate information associated with the corresponding selected resources via SCI. Another UE that receives the SCI may identify whether the resource indicated via SCI is a single resource or two resources, so as to identify whether the method to be used is a single-sided RTT method or RTT method 1.

In the case of the above-described method 2-1, various higher layer indication methods by a location server via SCI (e.g., 1st SCI and 2nd SCI), a PSSCH, a sidelink MAC-CE, PC5-RRC, or a positioning protocol may be considered. For example, in the case in which only single-sided RTT and double-sided RTT are supported, corresponding information is 1-bit information that may indicate which method is to be used between single-sided RTT or double-sided RTT. For example, in the case in which only single-sided RTT and RTT method 2 are supported, corresponding information is 1-bit information that may indicate whether the method is single-sided RTT or RTT method 2.

The above-described method 2-2 may be used to distinguish single-sided RTT and another RTT method (RTT method 1, RTT method 2, or double-sided RTT). A single-sided RTT method and RTT method 1 or RTT method 2 may be identified based on whether an anchor UE (e.g., UE-B in part (a) of FIG. 7, FIG. 8, and FIG. 9) reports only Treply1 or reports both Treply1 and Treply2 to a target UE (e.g., UE-A in part (a) of FIG. 7, FIG. 8, and FIG. 9). In the case in which only Treply1 is reported, it is identified that a single-sided RTT method is used. In the case in which both Treply1 and Treply2 are reported, it is identified that RTT method 1 or RTT method 2 is used. Single-sided RTT and double-sided RTT may be identified based on whether an anchor UE (e.g., UE-B in part (a) of FIG. 7 and part (b) of FIG. 7) reports only Treply1 or reports both Treply1 and Tround2 to a target UE (e.g., UE-A in part (a) of FIG. 7 and part (b) of FIG. 7). In the case in which only Treply1 is reported, it is identified that a single-sided RTT method is used. In the case in which both Treply1 and Tround2 are reported, it is identified that double-sided RTT is used.

### Embodiment 6

According to various embodiments of the disclosure, embodiment 6 will describe, in detail, a method of selecting an S-PRS resource in the case in which sidelink positioning is performed.

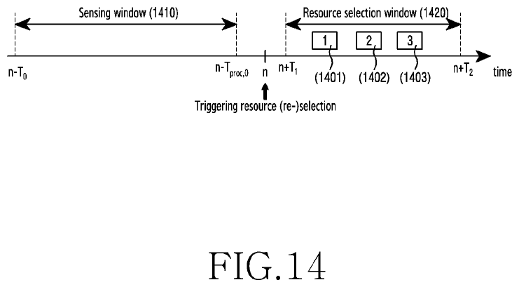

FIG. 14 illustrates a diagram of an example of a sensing window and a resource selection window according to various embodiments of the disclosure. FIG. 14 illustrates a sensing window 1410 and a resource selection window 1420 for selecting an S-PRS resource in scheme 2.

In scheme 2, a UE operation to select an S-PRS resource may need to be defined and may be performed according to the following procedure.
A UE may perform sensing in the sensing window 1410. To perform sensing may be defined as an operation of decoding SCI transmitted from another UE and of performing RSRP measurement. The SCI may include resource allocation information. Via SCI decoding, whether another UE occupies a resource in the resource selection window 1420 corresponding to a candidate resource area for transmission may be identified. In the case in which the other UE occupies a resource, how much interference occurs may be identified via RSRP measurement. Here, RSRP may be referred to as L1 RSRP. The L1 RSRP may be RSRP measured based on an S-PRS. According to an embodiment, the L1 RSRP may be RSRP measured based on a DMRS of a PSCCH region. According to an embodiment, the L1 RSRP may be RSRP measured via a DMRS of a PSSCH region. In the case in which one or more methods among the above-described methods are supported, which of the methods is to be used may be configured via a resource pool. For example, in the case in which both L1 RSRP using an S-PRS and L1 RSRP using a DMRS in a PSCCH region are supported, which of the methods is to be used may be (pre-)configured. N candidate resources may be selected via corresponding sensing.
A UE may arbitrarily select a resource for S-PRS transmission from N candidate resources selected via sensing. In this instance, according to various embodiments of the disclosure, methods for selecting resources for S-PRS transmission may not be limited to the following procedure.

In RTT method 1 according to an embodiment, referring to FIG. 8, the S-PRS transmission resources 805 and 806 may be simultaneously selected. For example, when resource selection is performed, two resources may be selected simultaneously. The S-PRS transmission resources 805 and 806 may correspond to an area 1401 and an area 1402 of the resource selection window 1420 of FIG. 14, respectively.

In RTT method 2 according to an embodiment, referring to FIG. 9, the S-PRS transmission resources 906 and 907 are simultaneously selected. For example, when resource selection is performed, two resources may be selected simultaneously. The S-PRS transmission resources 906 and 907 may correspond to an area 1401 and an area 1402 of the resource selection window 1420 of FIG. 14, respectively.

In RTT method 1 according to an embodiment, referring to FIG. 8, the S-PRS transmission resources 805 and 806 are simultaneously selected. In addition, UE-A may also select the S-PRS transmission resource 807 for UE-B at the same time and may indicate the same to the UE-B. That may be referred to as inter-UE coordination. In this instance, the S-PRS transmission resources 805, 806, and 807 may correspond to the area 1401, the area 1402, and an area 1403 of the resource selection window 1420 of FIG. 14, respectively.

In RTT method 2 according to an embodiment, referring to FIG. 9, the S-PRS transmission resources 906 and 907 are simultaneously selected. In this instance, in addition to the S-PRS transmission resource 905 of UE-A, UE-A may simultaneously select the S-PRS transmission resources 906 and 907 of UE-B and may indicate the same to the UE-B. That may be referred to as inter-UE coordination. In this instance, the S-PRS transmission resources 905, 906, and 907 may correspond to the area 1401, the area 1402, and an area 1403 of the resource selection window 1420 of FIG. 14, respectively.

### Embodiment 7

According to various embodiments of the disclosure, embodiment 7 will describe, in detail, a physical channel structure in which an S-PRS is transmitted in the case in which sidelink positioning is performed.

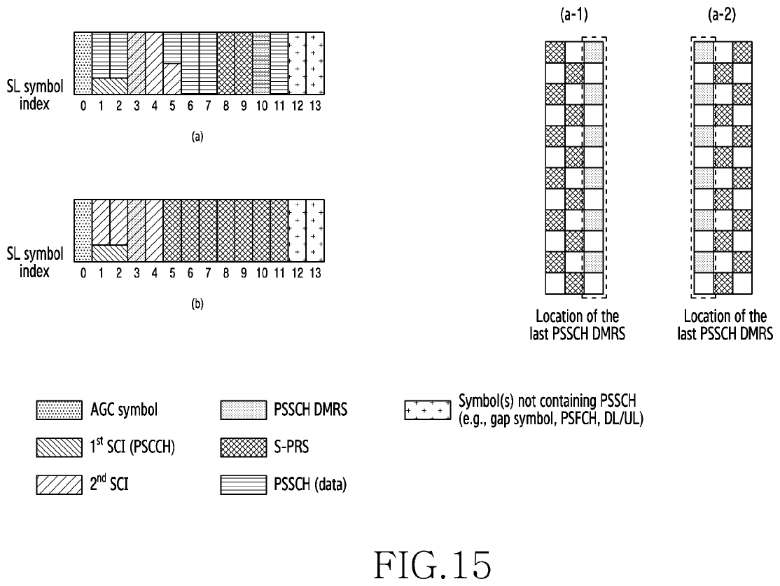

FIG. 15 illustrates a diagram of examples of a physical channel structure in which an S-PRS is transmitted according to various embodiments of the disclosure. Part (a) of FIG. 15 illustrates the case in which an S-PRS is transmitted in a resource pool for sidelink communication and the case in which an S-PRS is located based on the last symbol of a PSSCH DMRS. According to an embodiment, as illustrated in part (a-1) of FIG. 15 and part (a-2) of FIG. 15, the case in which the last symbol of a PSSCH DMRS is also utilized as an S-PRS may also be taken into consideration.

Part (a-1) of FIG. 15 illustrates the case in which an S-PRS is located before the last symbol of the PSSCH DMRS, and part (a-2) of FIG. 15 illustrates the case in which an S-PRS is located after the last symbol of the PSSCH DRMS.

According to an embodiment, in part (a-1) of FIG. 15, the case in which the last symbol of the PSSCH DMRS is excluded and an S-PRS is located before the corresponding symbol may be considered. According to an embodiment, in part (a-2) of FIG. 15, the case in which the last symbol of the PSSCH DMRS is excluded and an S-PRS is located after the corresponding symbol may be considered. When the above-described methods are used, M symbols may be transmitted as an S-PRS, and M may be limited to a value of 1 or 2. However, in the disclosure, a value configured as M is not limited to a predetermined value.

According to an embodiment, referring to part (a) of FIG. 15, in the case in which an S-PRS is transmitted in a resource pool for sidelink communication, the case in which data is transmitted together with an S-PRS in a PSSCH region may be taken into consideration. Referring to part (a) of FIG. 15, data may be transmitted in the PSSCH region. In the case in which data is not transmitted together with an S-PRS in the PSSCH region, 2nd SCI may be mapped to the entire region of the PSSCH and may be transmitted. Part (a) of FIG. 15 illustrates the case in which 2nd SCI is mapped from the first symbol of the PSSCH DMRS and is transmitted. However, in the case in which data is not transmitted together with an S-PRS in the PSSCH region, 2nd SCI may be mapped to the entire region of the PSSCH and may be transmitted. In the case in which an empty symbol that transmits nothing is present in the PSSCH region, a power imbalance issue may occur.

According to an embodiment, part (b) of FIG. 15 illustrates a location in which an S-PRS is transmitted in the case in which the S-PRS is transmitted in a resource pool dedicated to S-PRS transmission. In this instance, the S-PRS may be transmitted from a symbol after a last symbol in which 2nd SCI is transmitted as shown in part (b) of FIG. 15. As illustrated in part (b) of FIG. 15, a resource pool dedicated only to S-PRS transmission has a feature in which 2nd SCI is mapped over the entire region from the first symbol of the PSSCH region to the last symbol to which 2nd SCI is mapped. In addition, the resource pool dedicated only to S-PRS transmission has a feature in which a PSSCH DMRS is transmitted only in a region to which 2nd SCI is mapped, and is not transmitted in the other region. For example, symbols in which a PSSCH DMRS is transmitted is configured to be a third symbol and a tenth symbol as shown in part (a) of FIG. 15. However, in the resource pool dedicated only to S-PRS transmission, the PSSCH DMRS may not be transmitted in the tenth symbol to which 2nd SCI is not mapped. In addition, an S-PRS may be used for channel estimation for 2nd SCI decoding.

### Embodiment 8

According to various embodiments of the disclosure, embodiment 8 will describe, in detail, a method of producing an S-PRS sequence in the case in which sidelink positioning is performed. Specifically, a method of determining a parameter needed for producing a Pseudorandom-based S-PRS sequence in consideration of a sidelink environment will be described.

In a sidelink, there may be a case in which a UE is in a base station coverage and a case in which a UE is outside the base station coverage. Therefore, a method of determining a predetermined parameter may need to be determined, irrespective of whether a UE is inside or outside coverage. For example, a method in which a base station determines and indicates a predetermined parameter is only available when a UE is inside coverage, and thus the method is unavailable when the UE is outside the coverage.

A Pseudorandom sequence may be defined based on a Gold sequence having a length of 31, and a Pseudorandom sequence c(n) having a length of M_PN may be defined as given in the equation below.

$$c ( n ) = ( {x}_{1} ( n + {N}_{c} ) + {x}_{2} ( n + {N}_{c} ) ) mod 2 \qquad [ Equation 12 ]$$

$${x}_{1} ( n + 31 ) = ( {x}_{1} ( n + 3 ) + {x}_{1} ( n ) ) mod 2$$

$${x}_{2} ( n + 31 ) = ( {x}_{2} ( n + 3 ) + {x}_{2} ( n + 2 ) + {x}_{2} ( n + 1 ) ) mod 2$$

In Equation 12, N_{c}=1600, and x₁(n) that is a first m-sequence may be initialized to be x₁(0)=1, x₁(n)=0, n=1, 2, . . . , 30. The initiation of x₂(n) that is a second m-sequence may be expressed as cᵢₙᵢₜ=Σᵢ₌₀³⁰x₂(i)·2ⁱ, and, depending on the application of the sequence, the corresponding value may be determined and initialized.

Specifically, the Pseudorandom-based S-PRS sequence may be defined as given in the equation below.

$$r ( m ) = \frac{1}{\sqrt{2}} ( 1 - 2 c ( 2 m ) ) + j \frac{1}{\sqrt{2}} ( 1 - 2 c ( 2 m + 1 ) ) \qquad [ Equation 13 ]$$

In Equation 13, c(i) has been given in Equation 12 and the Pseudorandom sequence may be initialized according to Equations 14 to 16 below. According to various embodiments of the disclosure, the initialization method, of course, is not limited to Equations 14 to 16. In the following Equations 14 to 16, 4096 S-PRS sequence IDs (N_“ID”∈E{0, 1, . . . , 4095}) are assumed to be used. However, according to various embodiments of the disclosure, the number of S-PRS sequence IDs, of course, is not limited to a predetermined value.

$${c}_{init} = ( {2}^{22} ⌊ \frac{{N}_{ID}}{1024} ⌋ + {2}^{10} ( {N}_{symb}^{slot} {n}_{s , f}^{μ} + l + 1 ) ( 2 ( {N}_{ID} mod 1024 ) + 1 ) + ( {N}_{ID} mod 1024 ) ) mod {2}^{31} \qquad [ Equation 14 ]$$

$${c}_{init} = ( {2}^{12} ( {N}_{symb}^{slot} {n}_{s , f}^{μ} + l + 1 ) ( 2 {N}_{ID} + 1 ) + {N}_{ID} ) mod {2}^{31} \qquad [ Equation 15 ]$$

$${c}_{init} = ( {2}^{17} ( {N}_{symb}^{slot} {n}_{s , f}^{μ} + l + 1 ) ( 2 {N}_{ID} + 1 ) + 2 {N}_{ID} ) mod {2}^{31} \qquad [ Equation 16 ]$$

In Equations 14 to 16, N_{symb}^{slot} is 14 in the case of a normal cyclic prefix, and is 12 in the case of an extended cyclic prefix. n_{s,f}^{μ} denotes a slot number in a frame, and l denotes an OFDM symbol number.

In the disclosure, methods of determining N_{ID} (S-PRS sequence ID) in the above-described equations are described. According to various embodiments of the disclosure, as a matter of course, the method of determining N_{ID} is not limited to the following methods. In addition, one or more among the following methods may be used in combination. In addition, whether one or more of the following methods are supported, and which method is to be used may be (pre-)configured. In the following methods, in the case in which 4096 S-PRS sequence IDs are assumed to be used, 12 bits may be needed. Therefore, a value in a parenthesis given below, of course, may be differ depending on the number of S-PRS sequence IDs.

Method of determining N_{ID} S-PRS sequence ID)
Method 1: determined by the [12] bits LSB of CRC of the corresponding 1st SCI
Method 2: determined by the [12] bits LSB of destination ID carried in the 1st or 2nd SCI
Method 3: determined by the [8] bits of the source ID carried in the 1st or 2nd SCI+[4] zero bits
Method 4: determined by (pre-)configured value
Method 5: determined into fixed value (i.e., zero)
Method 6: determined by the [12] bits in the 1st or 2nd SCI
Method 7: determined by the [12] bits in TMSI (Temporary Mobile Subscriber Identity)
Method 8: determined by the [12] bits from S-PRS ID determined by the IMEI (International Mobile Equipment Identity)
Method 9: determined by higher layer configuration

Method 1 assumes that a PSCCH (e.g., 1st SCI) is transmitted in a slot in which an S-PRS is transmitted. However, in the case in which a PSCCH is not transmitted in every slot in which an S-PRS is transmitted, operation may be performed based on a PSSCH (e.g., 1st SCI) transmitted latest.

According to method 1, it is determined that N_{ID}=N_{ID}^{X} mod 2¹². Here, N_{ID}^{X}=Σᵢ₌₀^{L-1}pᵢ·2^{L-1-i}, L=24, and p denotes parity bits p₀, p₁, p₂, p₃, . . . , p_{L-1} used for calculating a CRC of a PSCCH and may be produced by cyclic generator polynomials. In method 1, although it is assumed that information of [12] bits is used on the assumption of 4096 S-PRS sequence IDs, the number of S-PRS sequence IDs in the disclosure is not limited to a predetermined value. For example, in the case in which 2^{Y} S-PRS sequence IDs are used, it is determined that N_{ID} N_{ID}^{X} mod 2^{Y}.

Method 2 assumes that a PSCCH (e.g., 1st SCI and 2nd SCI) is transmitted in a slot in which an S-PRS is transmitted. It is assumed that 1st SCI or 2nd SCI includes a destination ID. The destination ID is assumed to be 16 bits. However, in the disclosure, the destination ID is not limited to 16 bits.

In the case in which 1st SCI or 2nd SCI is not transmitted in every slot in which an S-PRS is transmitted, operation based on a destination ID included in 1st SCI or 2nd SCI transmitted latest may be considered. In method 2, although it is assumed that information of [12]bits is used on the assumption of 4096 S-PRS sequence IDs, the number of S-PRS sequence IDs in the disclosure is not limited to a predetermined value. In the case in which 2^{Y} S-PRS sequence IDs are used, [12] bits may be replaced with Y bits on the assumption of Y≤16.

Method 3 assumes that a PSCCH (e.g., 1st SCI and 2nd SCI) is transmitted in a slot in which an S-PRS is transmitted. It is assumed that 1st SCI or 2nd SCI includes a source ID. The source ID is assumed to be 8 bits. However, in the disclosure, the source ID is not limited to 8 bits.

In the case in which 1st SCI or 2nd SCI is not transmitted in every slot in which an S-PRS is transmitted, operation based on a source ID included in 1st SCI or 2nd SCI transmitted latest may be considered. In method 3, although it is assumed that information of 12 bits is needed on the assumption of 4096 S-PRS sequence IDs, the number of S-PRS sequence IDs in the disclosure is not limited to a predetermined value. For example, the number of zero bits required may differ depending on the number of bits of a source ID and the number of bits of an S-PRS sequence ID, which are required.

Method 4 and method 5 may have difficulty in randomizing N_{D} according to a method in which N (S-PRS sequence ID) is (pre-)configured or fixed to be a predetermined value. In method 6, a UE may randomly select and determine a corresponding value according to a method in which Nm (S-PRS sequence ID) is separately indicated via 1st SCI or 2nd SCI. In methods 4 to 6, although it is assumed that information of 12 bits is needed on the assumption of 4096 S-PRS sequence IDs, the number of S-PRS sequence IDs in the disclosure is not limited to a predetermined value.

Method 7 is a method of selecting 12 LSB bits in consideration that a temporary mobile subscriber identity (TMSI) is 4 octets. Method 8 is a method of determining an S-PRS sequence ID based on an international mobile equipment identity (IMEI) that is a unique UE ID number. In methods 7 to 8, although it is assumed that information of 12 bits is needed on the assumption of 4096 S-PRS sequence IDs, the number of S-PRS sequence IDs in the disclosure is not limited to a predetermined value.

As an example of using the above-described methods in combination, the case in which method 1 and method 9 are combined may be considered. Method 9 may be a method based on a higher layer configuration, and the configuration may be performed by a sidelink positioning protocol (SLPP). According to various embodiments of the disclosure, in the case in which configuration information is received according to method 9, operation may be performed according to method 9. Otherwise, operation may be performed according to method 1.

### Embodiment 9

According to various embodiments of the disclosure, embodiment 9 will describe, in detail, a method of indicating information related to S-PRS transmission via SCI in the case in which sidelink positioning is performed. As described with reference to FIG. 15, two stage SCI (e.g., 1st SCI and 2nd SCI) may be transmitted when S-PRS transmission is performed.

Here, 1st SCI may include information related to resource allocation for an S-PRS, and more particularly, may be defined in a new 1st SCI format by including the following information. The disclosure, of course, does not limit 1st SCI information included in S-PRS transmission only to the information as follows.
Priority of S-PRS
   The corresponding information is L1 priority information of an S-PRS and may be provided via a higher layer of a UE.
Frequency resource assignment for SL PRS
   The corresponding information is information associated a frequency domain to which an S-PRS resource is allocated.
Time resource assignment for SL PRS
   The corresponding information is information associated with a time domain to which an S-PRS resource is allocated, and may refer to the description of embodiment 6 and the description of FIG. 14.
Resource reservation period, periodicity of S-PRS.
   The corresponding information may be periodic resource reservation information associated with an S-PRS.
2nd stage SCI format.
   The corresponding information may be information indicating a format of 2nd SCI.
Reserved bits
   Reserved bits may be included for additional information to be used in the future.

In addition, 2nd SCI may include application-specific information needed for S-PRS transmission. That may be defined in a new 2nd SCI format by including the following information in consideration of unicast and groupcast transmission of an S-PRS. The disclosure, of course, does not limit 2nd information (e.g., 2nd SCI) included in S-PRS transmission only to the information as follows.
Source ID
Destination ID
Coordinate information
   The corresponding information may be (x, y, x) or (x, y) coordinate location information provided by an anchor UE.
Reliability information
   The corresponding information may be confidence information associated with positioning (e.g., the confidence level of coordinate information). The corresponding information may be quantized to be probability information in the range of 0 to 1 and may be provided.

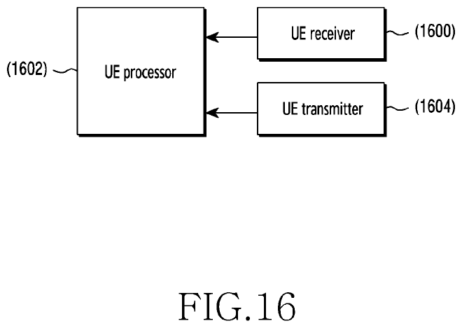

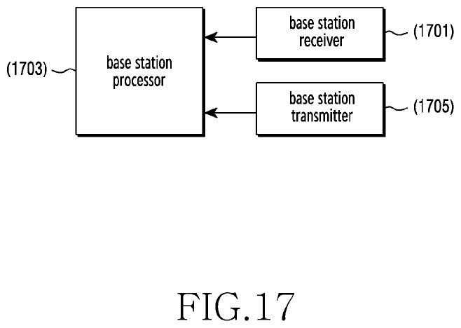

To perform the above-described embodiments of the disclosure, a transmitter, a receiver, and a processor of each of a UE and a base station are illustrated in FIGS. 16 and 17. According to various embodiments, a method in which a UE performs positioning in a sidelink is described, and to perform the same, a receiver, a processor, and a transmitter of each of a UE and a base station may operate according to each embodiment.

FIG. 16 illustrates a diagram of a functional configuration of a UE according to various embodiments of the disclosure. Particularly, FIG. 16 illustrates a block diagram of the internal structure of a UE according to an embodiment of the disclosure.

As illustrated in FIG. 16, the UE of the disclosure may include a UE receiver 1600, a UE transmitter 1604, and a UE processor 1602. The UE receiver 1600 and the UE transmitter 1604 may be collectively called a transceiver in the embodiments of the disclosure. The transceiver may perform signal transmission or reception with a base station. The signal may include control information and data. To this end, the transceiver may include an RF transmitter that up-converts and amplifies a frequency of a transmitted signal, an RF receiver that low-noise amplifies a received signal and down-converts a frequency, and the like. In addition, the transceiver outputs, to the UE processor 1602, a signal received via a wireless channel, and transmits a signal output from the UE processor 1602 via a wireless channel. The UE processor 1602 may control a series of processes so that the UE operates according to the above-described embodiments of the disclosure.

FIG. 17 illustrates a diagram of a functional configuration of a base station according to various embodiments of the disclosure. FIG. 17 illustrates a block diagram of the internal structure of a base station according to an embodiment of the disclosure.

As illustrated in FIG. 17, the base station of the disclosure may include a base station receiver 1701, a base station transmitter 1705, and a base station processor 1703. The base station receiver 1701 and the base station transmitter 1705 are collectively called a transceiver in the embodiments of the disclosure. The transceiver may perform signal transmission or reception with a UE. The signal may include control information and data. To this end, the transceiver may include an RF transmitter that up-converts and amplifies a frequency of a transmitted signal, an RF receiver that low-noise amplifies a received signal and down-converts a frequency, and the like. In addition, the transceiver outputs, to the base station processor 1703, a signal received via a wireless channel, and transmits a signal output from the base station processor 1703 via a wireless channel. The base station processor 1703 may control a series of processes so that the base station operates according to the above-described embodiments of the disclosure.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, all the embodiments of the disclosure may be partially combined with each other to operate a base station and a terminal.

Although the present disclosure has been described with various embodiments, various changes and modifications may be suggested to one skilled in the art. It is intended that the present disclosure encompass such changes and modifications as fall within the scope of the appended claims.

What is claimed is:

1. A first user equipment (UE) in a wireless communication system, the first UE comprising:
a transceiver; and
a controller coupled with the transceiver, and configured to:
transmit, to a second UE, a first sidelink positioning reference signal (SL PRS),
receive, from the second UE, a second SL PRS, and
identify a SL PRS time difference based on the first SL PRS and the second SL PRS,
wherein the SL PRS time difference is a difference between a received timing of a sidelink subframe #i associated with the first SL PRS and a transmit timing of a sidelink subframe #j associated with the second SL PRS, according to an indication via a higher layer signaling.

2. The first UE of claim 1,
wherein the SL PRS time difference is a difference between the received timing of the sidelink subframe #i associated with the first SL PRS and a transmit timing of the sidelink subframe #j associated with the second SL PRS that is closest in time to the sidelink subframe #i, according to the indication via the higher layer signaling.

3. The first UE of claim 1,
wherein the first SL PRS or the second SL PRS is generated according to a SL PRS sequence based on a pseudo-random sequence, and
wherein, in case that a sequence identifier (ID) for the SL PRS sequence is not provided by the higher layer signaling, the sequence ID is determined by a bit of a cyclic redundancy check (CRC) attached to sidelink control information (SCI) associated with the first SL PRS and the second SL PRS.

4. The first UE of claim 3,
wherein the SL PRS sequence (r(m)) is defined according to:
$$r ( m ) = \frac{1}{\sqrt{2}} ( 1 - 2 c ( 2 m ) ) + j \frac{1}{\sqrt{2}} ( 1 - 2 c ( 2 m + 1 ) ) ,$$
wherein the c(i) denotes the pseudo-random sequence.

5. The first UE of claim 3,
wherein the pseudo-random sequence is initialized with according to:
$${c}_{init} = ( {2}^{22} ⌊ \frac{{n}_{ID , seq}^{SL - PRS}}{1024} ⌋ + {2}^{10} ( {N}_{symb}^{slot} {n}_{s , f}^{μ} + l + 1 ) ( 2 ( {n}_{ID , seq}^{SL - PRS} mod 1024 ) + 1 ) + ( {n}_{ID , seq}^{SL - PRS} mod 1024 ) ) mod {2}^{31} ,$$
wherein the n_{s,f}^{μ} denotes a slot number within a radio frame, l denotes an orthogonal frequency division multiplexing (OFDM) symbol number within a slot to which the SL PRS sequence is mapped, and n_{ID,seq}^{SL-PRS} denotes the sequence ID.

6. The first UE of claim 3, wherein the controller is further configured to:
receive, via the higher layer signaling, information configuring the sequence ID, and
transmit, to the second UE via the higher layer signaling, the information configuring the sequence ID.

7. The first UE of claim 3,
wherein the higher layer signaling is based on a sidelink positioning protocol (SLPP) between a location management function (LMF) entity and at least one UE.

8. A method performed by a first user equipment (UE) in a wireless communication system, the method comprising:
transmitting, to a second UE, a first sidelink positioning reference signal (SL PRS);
receiving, from the second UE, a second SL PRS; and
identifying a SL PRS time difference based on the first SL PRS and the second SL PRS,
wherein the SL PRS time difference is a difference between a received timing of a sidelink subframe #i associated with the first SL PRS and a transmit timing of a sidelink subframe #j associated with the second SL PRS, according to an indication via a higher layer signaling.

9. The method of claim 8,
wherein the SL PRS time difference is a difference between the received timing of the sidelink subframe #i associated with the first SL PRS and a transmit timing of the sidelink subframe #j associated with the second SL PRS that is closest in time to the sidelink subframe #i, according to the indication via the higher layer signaling.

10. The method of claim 8,
wherein the first SL PRS or the second SL PRS is generated according to a SL PRS sequence based on a pseudo-random sequence, and
wherein, in case that a sequence identifier (ID) for the SL PRS sequence is not provided by the higher layer signaling, the sequence ID is determined by a bit of a cyclic redundancy check (CRC) attached to sidelink control information (SCI) associated with the first SL PRS and the second SL PRS.

11. The method of claim 10,
wherein the SL PRS sequence (r(m)) is defined according to:
$$r ( m ) = \frac{1}{\sqrt{2}} ( 1 - 2 c ( 2 m ) ) + j \frac{1}{\sqrt{2}} ( 1 - 2 c ( 2 m + 1 ) ) ,$$
wherein the c(i) denotes the pseudo-random sequence.

12. The method of claim 10,
wherein the pseudo-random sequence is initialized with according to:
$${c}_{init} = ( {2}^{22} ⌊ \frac{{n}_{ID , seq}^{SLPRS}}{1024} ⌋ + {2}^{10} ( {N}_{symb}^{slot} {n}_{s , f}^{μ} + l + 1 ) ( 2 ( {n}_{ID , seq}^{SL - PRS} mod 1024 ) + 1 ) + ( {n}_{ID , seq}^{SL - PRS} mod 1024 ) ) mod {2}^{31} ,$$
wherein the n_{s,f}^{μ} denotes a slot number within a radio frame, l denotes an orthogonal frequency division multiplexing (OFDM) symbol number within a slot to which the SL PRS sequence is mapped, and n_{ID,seq}^{SL-PRS} denotes the sequence ID.

13. The method of claim 10, further comprising:
receiving, via the higher layer signaling, information configuring the sequence ID, and
transmitting, to the second UE via the higher layer signaling, the information configuring the sequence ID.

14. The method of claim 10,
wherein the higher layer signaling is based on a sidelink positioning protocol (SLPP) between a location management function (LMF) entity and at least one UE.
